(19) United States
(12) Patent Application Publication
(10) Pub. No.: US 2024/0296649 A1
(43) Pub. Date: Sep. 5, 2024

(54) METHOD AND APPARATUS FOR ENCODING/DECODING FEATURE INFORMATION ON BASIS OF GENERAL-PURPOSE TRANSFORMATION MATRIX, AND RECORDING MEDIUM FOR STORING BITSTREAM

(71) Applicant: LG Electronics Inc., Seoul (KR)

(72) Inventors: Chulkeun KIM, Seoul (KR); Jaehyun LIM, Seoul (KR)

(21) Appl. No.: 18/571,028

(22) PCT Filed: Jun. 15, 2022
(86) PCT No.: PCT/KR2022/008491

§ 371 Date: Dec. 15, 2023

(30) Foreign Application Priority Data
Jun. 15, 2021 (KR) 10-2021-0077104

(51) Int. Cl. G06V 10/42; G06V 10/25

(52) U.S. Cl. CPC G06V 10/42; G06V 10/25

(57) ABSTRACT

A method and apparatus for encoding/decoding feature information of an image and a computer-readable recording medium generated by the encoding method are provided. The encoding method comprises obtaining at least one feature map for a first image, determining at least one feature transform matrix for the feature map, and transforming a plurality of features included in the feature map based on the determined feature transform matrix. The at least one feature transform matrix may comprise a global feature transform matrix commonly applied to two or more features, and the global feature transform matrix may be generated in advance based on a predetermined feature data set obtained from a second image.

### TECHNICAL FIELD

The present disclosure relates to an encoding/decoding method and apparatus, and, more particularly, to a feature information encoding/decoding method and apparatus based on a global transform matrix, and a recording medium storing a bitstream generated by the feature information encoding method/apparatus of the present disclosure.

### BACKGROUND

Recently, demand for high-resolution and high-quality images such as high definition (HD) images and ultra high definition (UHD) images is increasing in various fields. As resolution and quality of image data are improved, the amount of transmitted information or bits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### SUMMARY

An object of the present disclosure is to provide a feature information encoding/decoding method and apparatus with improved encoding/decoding efficiency.

Another object of the present disclosure is to provide a feature information encoding/decoding method and apparatus that performs feature transform/inverse transform based on a global transform matrix.

Another object of the present disclosure is to provide a method of transmitting a bitstream generated by a feature information encoding method or apparatus.

Another object of the present disclosure is to provide a recording medium storing a bitstream generated by a feature information encoding method or apparatus according to the present disclosure.

Another object of the present disclosure is to provide a recording medium storing a bitstream received, decoded and used to reconstruct an image by a feature information decoding apparatus according to the present disclosure.

The technical problems solved by the present disclosure are not limited to the above technical problems and other technical problems which are not described herein will become apparent to those skilled in the art from the following description.

A method of decoding feature information of an image according to an aspect of the present disclosure may comprise obtaining at least one feature map for a first image, determining at least one feature transform matrix for the feature map, and inversely transform a plurality of features included in the feature map based on the determined feature transform matrix. The at least one feature transform matrix may comprise a global feature transform matrix commonly applied to two or more features, and the global feature transform matrix may be generated in advance based on a predetermined feature data set obtained from a second image.

An apparatus for decoding feature information of an image according to another aspect of the present disclosure may comprise a memory and at least one processor. The at least one processor may obtain at least one feature map for a first image, determine at least one feature transform matrix for the feature map, and inversely transform a plurality of features included in the feature map based on the determined feature transform matrix. The at least one feature transform matrix may comprise a global feature transform matrix commonly applied to two or more features, and the global feature transform matrix may be generated in advance based on a predetermined feature data set obtained from a second image.

A method of encoding feature information of an image according to another aspect of the present disclosure may comprise obtaining at least one feature map for a first image, determining at least one feature transform matrix for the feature map and transforming a plurality of features included in the feature map based on the determined feature transform matrix. The at least one feature transform matrix may comprise a global feature transform matrix commonly applied to two or more features, and the global feature transform matrix may be generated in advance based on a predetermined feature data set obtained from a second image.

An apparatus for encoding feature information of an image according to another aspect of the present disclosure may comprise a memory and at least one processor. The at least one processor may obtain at least one feature map for a first image, determine at least one feature transform matrix for the feature map and transform a plurality of features included in the feature map based on the determined feature transform matrix. The at least one feature transform matrix may comprise a global feature transform matrix commonly applied to two or more features, and the global feature transform matrix may be generated in advance based on a predetermined feature data set obtained from a second image.

In addition, a recording medium according to another aspect of the present disclosure may store the bitstream generated by a feature information encoding apparatus or a feature information encoding method of the present disclosure.

In addition, a bitstream transmission method according to another aspect of the present disclosure may transmit a bitstream generated by a feature information encoding apparatus or a feature information encoding method of the present disclosure to a feature information decoding apparatus.

The features briefly summarized above with respect to the present disclosure are merely exemplary aspects of the detailed description below of the present disclosure, and do not limit the scope of the present disclosure.

According to the present disclosure, it is possible to provide a feature information encoding/decoding method and apparatus with improved encoding/decoding efficiency.

Also, according to the present disclosure, it is possible to provide an image encoding/decoding method and apparatus for performing feature transform/inverse transform based on a global transform matrix.

Also, according to the present disclosure, it is possible to provide a method of transmitting a bitstream generated by a feature information encoding method or apparatus according to the present disclosure.

Also, according to the present disclosure, it is possible to provide a recording medium storing a bitstream generated by a feature information encoding method or apparatus according to the present disclosure.

Also, according to the present disclosure, it is possible to provide a recording medium storing a bitstream received, decoded and used to reconstruct a feature by a feature information decoding apparatus according to the present disclosure.

It will be appreciated by persons skilled in the art that that the effects that can be achieved through the present disclosure are not limited to what has been particularly described hereinabove and other advantages of the present disclosure will be more clearly understood from the detailed description.

### BRIEF DESCRIPTION OF THE DRAWINGS

FIG. 1 is a view schematically showing a video coding system, to which embodiments of the present disclosure are applicable.

FIG. 2 is a view schematically showing an image encoding apparatus, to which embodiments of the present disclosure are applicable.

FIG. 3 is a view schematically showing an image decoding apparatus, to which embodiments of the present disclosure are applicable.

FIG. 4 is a flowchart schematically illustrating a picture decoding procedure, to which embodiments of the present disclosure are applicable.

FIG. 5 is a flowchart schematically illustrating a picture encoding procedure, to which embodiments of the present disclosure are applicable.

FIG. 6 is a view showing a hierarchical structure for a coded image.

FIG. 7 is a view schematically illustrating a VCM system to which embodiments of the present disclosure are applicable.

FIG. 8 is a diagram illustrating an example of a VCM pipeline applicable to embodiments of the present disclosure.

FIGS. 9 to 11 are diagrams illustrating operation of a feature extraction network.

FIG. 12 is a diagram illustrating a PCA based feature transform process.

FIGS. 13 to 15 are diagrams illustrating a feature data set construction method according to an embodiment of the present disclosure.

FIGS. 16 to 18 are diagrams illustrating a feature transform matrix generation method according to an embodiment of the present disclosure.

FIG. 19 is a diagram schematically illustrating an encoder/decoder structure according to an embodiment of the present disclosure.

FIGS. 20 and 21 are diagrams illustrating a method of generating a feature data set according to an embodiment of the present disclosure.

FIG. 22 is a diagram illustrating a method of generating a plurality of feature transform matrices according to an embodiment of the present disclosure.

FIG. 23 is a diagram schematically illustrating an encoder/decoder structure according to an embodiment of the present disclosure.

FIG. 24 is a diagram illustrating a feature transform matrix generation method according to an embodiment of the present disclosure.

FIG. 25 is a diagram illustrating an example of clustering feature data sets according to an embodiment of the present disclosure.

FIG. 26 is a flowchart illustrating a method of determining a feature transform matrix at a decoding apparatus according to an embodiment of the present disclosure.

FIGS. 27 and 28 are diagrams illustrating a MPM encoding method of a feature transform matrix index according to an embodiment of the present disclosure.

FIG. 29 is a flowchart illustrating a feature information encoding method according to an embodiment of the present disclosure.

FIG. 30 is a flowchart illustrating a feature information decoding method according to an embodiment of the present disclosure.

FIG. 31 is a view illustrating an example of a content streaming system, to which embodiments of the present disclosure are applicable.

FIG. 32 is a view showing another example of a content streaming system, to which embodiments of the present disclosure are applicable.

### DETAILED DESCRIPTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, in case it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc. may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and terms used in the present disclosure may have a general meaning commonly used in the technical field, to which the present disclosure belongs, unless newly defined in the present disclosure.

The present disclosure may be applied to a method disclosed in a Versatile Video Coding (VVC) standard and/or a Video Coding for Machines (VCM) standard. In addition, the present disclosure may be applied to a method disclosed in an essential video coding (EVC) standard, AOMedia Video 1 (AV1) standard, 2nd generation of audio video coding standard (AVS2), or a next-generation video/image coding standard (e.g., H.267 or H.268, etc.).

This disclosure provides various embodiments related to video/image coding, and, unless otherwise stated, the embodiments may be performed in combination with each other. In the present disclosure, “video” refers to a set of a series of images according to the passage of time. An “image” may be information generated by artificial intelligence (AI). Input information used in the process of performing a series of tasks by AI, information generated during the information processing process, and the output information may be used as images. In the present disclosure, a “picture” generally refers to a unit representing one image in a specific time period, and a slice/tile is a coding unit constituting a part of a picture in encoding. One picture may be composed of one or more slices/tiles. In addition, a slice/tile may include one or more coding tree units (CTUs). The CTU may be partitioned into one or more CUs. A tile is a rectangular region present in a specific tile row and a specific tile column in a picture, and may be composed of a plurality of CTUs. A tile column may be defined as a rectangular region of CTUs, may have the same height as a picture, and may have a width specified by a syntax element signaled from a bitstream part such as a picture parameter set. A tile row may be defined as a rectangular region of CTUs, may have the same width as a picture, and may have a height specified by a syntax element signaled from a bitstream part such as a picture parameter set. A tile scan is a certain continuous ordering method of CTUs partitioning a picture. Here, CTUs may be sequentially ordered according to a CTU raster scan within a tile, and tiles in a picture may be sequentially ordered according to a raster scan order of tiles of the picture. A slice may contain an integer number of complete tiles, or may contain a continuous integer number of complete CTU rows within one tile of one picture. A slice may be exclusively included in a single NAL unit. One picture may be composed of one or more tile groups. One tile group may include one or more tiles. A brick may indicate a rectangular region of CTU rows within a tile in a picture. One tile may include one or more bricks. The brick may refer to a rectangular region of CTU rows in a tile. One tile may be split into a plurality of bricks, and each brick may include one or more CTU rows belonging to a tile. A tile which is not split into a plurality of bricks may also be treated as a brick.

In the present disclosure, a “pixel” or a “pel” may mean a smallest unit constituting one picture (or image). In addition, “sample” may be used as a term corresponding to a pixel. A sample may generally represent a pixel or a value of a pixel, and may represent only a pixel/pixel value of a luma component or only a pixel/pixel value of a chroma component.

In an embodiment, especially when applied to VCM, when there is a picture composed of a set of components having different characteristics and meanings, a pixel/pixel value may represent a pixel/pixel value of a component generated through independent information or combination, synthesis, and analysis of each component. For example, in RGB input, only the pixel/pixel value of R may be represented, only the pixel/pixel value of G may be represented, or only the pixel/pixel value of B may be represented. For example, only the pixel/pixel value of a luma component synthesized using the R, G, and B components may be represented. For example, only the pixel/pixel values of images and information extracted through analysis of R, G. and B components from components may be represented.

In the present disclosure, a“unit” may represent a basic unit of image processing. The unit may include at least one of a specific region of the picture and information related to the region. One unit may include one luma block and two chroma (e.g., Cb and Cr) blocks. The unit may be used interchangeably with terms such as “sample array”, “block” or “area” in some cases. In a general case, an M×N block may include samples (or sample arrays) or a set (or array) of transform coefficients of M columns and N rows. In an embodiment. In particular, especially when applied to VCM, the unit may represent a basic unit containing information for performing a specific task.

In the present disclosure, “current block” may mean one of “current coding block”, “current coding unit”, “coding target block”, “decoding target block” or “processing target block”. When prediction is performed, “current block” may mean “current prediction block” or “prediction target block”. When transform (inverse transform)/quantization (dequantization) is performed, “current block” may mean “current transform block” or “transform target block”. When filtering is performed, “current block” may mean “filtering target block”.

In addition, in the present disclosure, a “current block” may mean “a luma block of a current block” unless explicitly stated as a chroma block. The “chroma block of the current block” may be expressed by including an explicit description of a chroma block, such as “chroma block” or “current chroma block”.

In the present disclosure, the term “/” and “,” should be interpreted to indicate “and/or.” For instance, the expression “A/B” and “A, B” may mean “A and/or B.” Further, “A/B/C” and “A/B/C” may mean “at least one of A, B, and/or C.”

In the present disclosure, the term “or” should be interpreted to indicate “and/or.” For instance, the expression “A or B” may comprise 1) only “A”, 2) only “B”, and/or 3) both “A and B”. In other words, in the present disclosure, the term “or” should be interpreted to indicate “additionally or alternatively.”

### Overview of Video Coding System

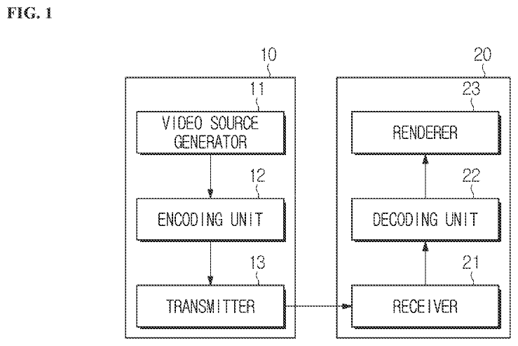

FIG. 1 is a view illustrating a video coding system, to which embodiments of the present disclosure are applicable.

The video coding system according to an embodiment may include a source device 10 and a reception device 20. The source device 10 may transmit encoded video and/or image information or data to the reception device 20 in the form of a file or streaming via a digital storage medium or network.

The source device 10 according to an embodiment may include a video source generator 11, an encoder 12 and a transmitter 13. The reception device 20 according to an embodiment may include a receiver 21, a decoder 22 and a renderer 23. The encoder 12 may be called a video/image encoding apparatus, and the decoding apparatus 22 may be called a video/image decoding apparatus. The transmitter 13 may be included in the encoder 12. The receiver 21 may be included in the decoder 22. The renderer 23 may include a display and the display may be configured as a separate device or an external component.

The video source generator 11 may obtain a video/image through a process of capturing, synthesizing or generating the video/image. The video source generator 11 may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data. In an embodiment, video/image synthesis and generation may be performed during an information processing process (AI input information, information in image processing, output information) by AI. In this case, information generated in the video/image capture process may be utilized as input information of AI.

The encoder 12 may encode an input video/image. The encoder 12 may perform a series of procedures such as prediction, transform, and quantization for compression and coding efficiency. The encoder 12 may output encoded data (encoded video/image information) in the form of a bitstream.

The transmitter 13 may transmit the encoded video/image information or data output in the form of a bitstream to the receiver 21 of the reception device 20 through a digital storage medium or a network in the form of a file or streaming. The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The receiver 21 may extract/receive the bitstream from the storage medium or network and transmit the bitstream to the decoder 22.

The decoder 22 may decode the video/image by performing a series of procedures such as dequantization, inverse transform, and prediction corresponding to the operation of the encoder 12.

The renderer 23 may render the decoded video/image. The rendered video/image may be displayed through the display.

The decoded video may be used not only for rendering but also as input information for use in other systems. For example, the decoded video may be utilized as input information for performing AI tasks. For example, the decoded video may be utilized as input information for performing AI tasks such as face recognition, behavior recognition, and lane recognition.

### Overview of Image Encoding Apparatus

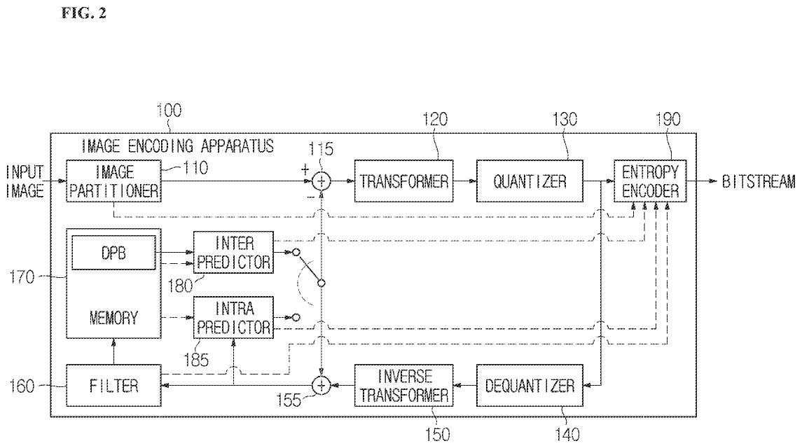

FIG. 2 is a view schematically showing an image encoding apparatus, to which embodiments of the present disclosure are applicable.

As shown in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter prediction unit 180, an intra prediction unit 185 and an entropy encoder 190. The inter prediction unit 180 and the intra prediction unit 185 may be collectively referred to as a “prediction unit”. The transformer 120, the quantizer 130, the dequantizer 140 and the inverse transformer 150 may be included in a residual processor. The residual processor may further include the subtractor 115.

All or at least some of the plurality of components configuring the image encoding apparatus 100 may be configured by one hardware component (e.g., an encoder or a processor) in some embodiments. In addition, the memory 170 may include a decoded picture buffer (DPB) and may be configured by a digital storage medium.

The image partitioner 110 may partition an input image (or a picture or a frame) input to the image encoding apparatus 100 into one or more processing units. Here, the input image may be a normal image obtained by an image sensor and/or an image generated by AI. For example, the processing unit may be called a coding unit (CU). The coding unit may be obtained by recursively partitioning a coding tree unit (CTU) or a largest coding unit (LCU) according to a quad-tree binary-tree ternary-tree (QT/BTT) structure. For example, one coding unit may be partitioned into a plurality of coding units of a deeper depth based on a quad tree structure, a binary tree structure, and/or a ternary structure. For partitioning of the coding unit, a quad tree structure may be applied first and the binary tree structure and/or ternary structure may be applied later. The coding procedure according to the present disclosure may be performed based on the final coding unit that is no longer partitioned. The largest coding unit may be used as the final coding unit or the coding unit of deeper depth obtained by partitioning the largest coding unit may be used as the final coding unit. Here, the coding procedure may include a procedure of prediction, transform, and reconstruction, which will be described later. As another example, the processing unit of the coding procedure may be a prediction unit (PU) or a transform unit (TU). The prediction unit and the transform unit may be split or partitioned from the final coding unit. The prediction unit may be a unit of sample prediction, and the transform unit may be a unit for deriving a transform coefficient and/or a unit for deriving a residual signal from the transform coefficient.

The prediction unit (the inter prediction unit 180 or the intra prediction unit 185) may perform prediction on a block to be processed (current block) and generate a predicted block including prediction samples for the current block. The prediction unit may determine whether intra prediction or inter prediction is applied on a current block or CU basis. The prediction unit may generate various information related to prediction of the current block and transmit the generated information to the entropy encoder 190. The information on the prediction may be encoded in the entropy encoder 190 and output in the form of a bitstream.

The intra prediction unit 185 may predict the current block by referring to the samples in the current picture. The referred samples may be located in the neighborhood of the current block or may be located apart according to the intra prediction mode and/or the intra prediction technique. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra prediction unit 185 may determine the prediction mode applied to the current block by using a prediction mode applied to a neighboring block.

The inter prediction unit 180 may derive a predicted block for the current block based on a reference block (reference sample array) specified by a motion vector on a reference picture. In this case, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like. The reference picture including the temporal neighboring block may be called a collocated picture (colPic). For example, the inter prediction unit 180 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter prediction unit 180 may use motion information of the neighboring block as motion information of the current block. In the case of the skip mode, unlike the merge mode, the residual signal may not be transmitted. In the case of the motion vector prediction (MVP) mode, the motion vector of the neighboring block may be used as a motion vector predictor, and the motion vector of the current block may be signaled by encoding a motion vector difference and an indicator for a motion vector predictor. The motion vector difference may mean a difference between the motion vector of the current block and the motion vector predictor.

The prediction unit may generate a prediction signal based on various prediction methods and prediction techniques described below. For example, the prediction unit may not only apply intra prediction or inter prediction but also simultaneously apply both intra prediction and inter prediction, in order to predict the current block. A prediction method of simultaneously applying both intra prediction and inter prediction for prediction of the current block may be called combined inter and intra prediction (CIIP). In addition, the prediction unit may perform intra block copy (IBC) for prediction of the current block. Intra block copy may be used for content image/video coding of a game or the like, for example, screen content coding (SCC). IBC is a method of predicting a current picture using a previously reconstructed reference block in the current picture at a location apart from the current block by a predetermined distance. When IBC is applied, the location of the reference block in the current picture may be encoded as a vector (block vector) corresponding to the predetermined distance. In IBC, prediction is basically performed in the current picture, but may be performed similarly to inter prediction in that a reference block is derived within the current picture. That is. IBC may use at least one of the inter prediction techniques described in the present disclosure.

The prediction signal generated by the prediction unit may be used to generate a reconstructed signal or to generate a residual signal. The subtractor 115 may generate a residual signal (residual block or residual sample array) by subtracting the prediction signal (predicted block or prediction sample array) output from the prediction unit from the input image signal (original block or original sample array). The generated residual signal may be transmitted to the transformer 120.

The transformer 120 may generate transform coefficients by applying a transform technique to the residual signal. For example, the transform technique may include at least one of a discrete cosine transform (DCT), a discrete sine transform (DST), a karhunen-love transform (KLT), a graph-based transform (GBT), or a conditionally non-linear transform (CNT). Here, the GBT means transform obtained from a graph when relationship information between pixels is represented by the graph. The CNT refers to transform obtained based on a prediction signal generated using all previously reconstructed pixels. In addition, the transform process may be applied to square pixel blocks having the same size or may be applied to blocks having a variable size rather than square.

The quantizer 130 may quantize the transform coefficients and transmit them to the entropy encoder 190. The entropy encoder 190 may encode the quantized signal (information on the quantized transform coefficients) and output a bitstream. The information on the quantized transform coefficients may be referred to as residual information. The quantizer 130 may rearrange quantized transform coefficients in a block form into a one-dimensional vector form based on a coefficient scanning order and generate information on the quantized transform coefficients based on the quantized transform coefficients in the one-dimensional vector form.

The entropy encoder 190 may perform various encoding methods such as, for example, exponential Golomb, context-adaptive variable length coding (CAVLC), context-adaptive binary arithmetic coding (CABAC), and the like. The entropy encoder 190 may encode information necessary for video/image reconstruction other than quantized transform coefficients (e.g., values of syntax elements, etc.) together or separately. Encoded information (e.g., encoded video/image information) may be transmitted or stored in units of network abstraction layers (NALs) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. In addition, the video/image information may include a method of generating and using encoded information, a purpose, and the like. For example, especially when applied to VCM, the video/image information may include information indicating which AI task the encoded information is encoded for, and which network (e.g. neural network) is used to encode the encoded information, and/or information indicating for what purpose the encoded information is encoded.

Information and/or syntax elements transmitted/signaled from the encoding apparatus of the present disclosure to the decoding apparatus may be included in video/image information. The signaled information, transmitted information and/or syntax elements described in the present disclosure may be encoded through the above-described encoding procedure and included in the bitstream. The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 190 and/or a storage unit (not shown) storing the signal may be included as internal/external element of the image encoding apparatus 100. Alternatively, the transmitter may be provided as the component of the entropy encoder 190.

The quantized transform coefficients output from the quantizer 130 may be used to generate a residual signal. For example, the residual signal (residual block or residual samples) may be reconstructed by applying dequantization and inverse transform to the quantized transform coefficients through the dequantizer 140 and the inverse transformer 150.

The adder 155 adds the reconstructed residual signal to the prediction signal output from the inter prediction unit 180 or the intra prediction unit 185 to generate a reconstructed signal (reconstructed picture, reconstructed block, reconstructed sample array). In case there is no residual for the block to be processed, such as a case where the skip mode is applied, the predicted block may be used as the reconstructed block. The adder 155 may be called a reconstructor or a reconstructed block generator. The generated reconstructed signal may be used for intra prediction of a next block to be processed in the current picture and may be used for inter prediction of a next picture through filtering as described below.

The filter 160 may improve subjective/objective image quality by applying filtering to the reconstructed signal. For example, the filter 160 may generate a modified reconstructed picture by applying various filtering methods to the reconstructed picture and store the modified reconstructed picture in the memory 170, specifically, a DPB of the memory 170. The various filtering methods may include, for example, deblocking filtering, a sample adaptive offset, an adaptive loop filter, a bilateral filter, and the like. The filter 160 may generate various information related to filtering and transmit the generated information to the entropy encoder 190 as described later in the description of each filtering method. The information related to filtering may be encoded by the entropy encoder 190 and output in the form of a bitstream.

The modified reconstructed picture transmitted to the memory 170 may be used as the reference picture in the inter prediction unit 180. When inter prediction is applied through the image encoding apparatus 100, prediction mismatch between the image encoding apparatus 100 and the image decoding apparatus may be avoided and encoding efficiency may be improved.

The DPB of the memory 170 may store the modified reconstructed picture for use as a reference picture in the inter prediction unit 180. The memory 170 may store the motion information of the block from which the motion information in the current picture is derived (or encoded) and/or the motion information of the blocks in the picture that have already been reconstructed. The stored motion information may be transmitted to the inter prediction unit 180 and used as the motion information of the spatial neighboring block or the motion information of the temporal neighboring block. The memory 170 may store reconstructed samples of reconstructed blocks in the current picture and may transfer the reconstructed samples to the intra prediction unit 185.

### Overview of Image Decoding Apparatus

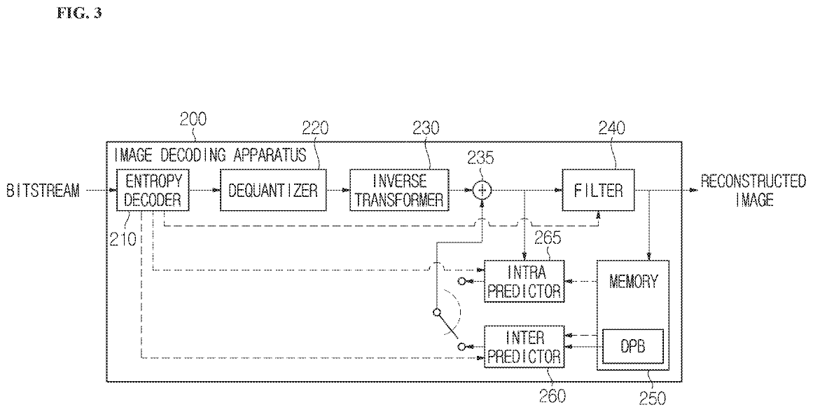

FIG. 3 is a view schematically showing an image decoding apparatus, to which embodiments of the present disclosure are applicable.

As shown in FIG. 3, the image decoding apparatus 200 may include an entropy decoder 210, a dequantizer 220, an inverse transformer 230, an adder 235, a filter 240, a memory 250, an inter prediction unit 260 and an intra prediction unit 265. The inter prediction unit 260 and the intra prediction unit 265 may be collectively referred to as a “prediction unit”. The dequantizer 220 and the inverse transformer 230 may be included in a residual processor.

All or at least some of a plurality of components configuring the image decoding apparatus 200 may be configured by a hardware component (e.g., a decoder or a processor) according to an embodiment. In addition, the memory 170 may include a decoded picture buffer (DPB) or may be configured by a digital storage medium.

The image decoding apparatus 200, which has received a bitstream including video/image information, may reconstruct an image by performing a process corresponding to a process performed by the image encoding apparatus 100 of FIG. 2. For example, the image decoding apparatus 200 may perform decoding using a processing unit applied in the image encoding apparatus. Thus, the processing unit of decoding may be a coding unit, for example. The coding unit may be obtained by partitioning a coding tree unit or a largest coding unit. The reconstructed image signal decoded and output through the image decoding apparatus 200 may be reproduced through a reproducing apparatus (not shown).

The image decoding apparatus 200 may receive a signal output from the image encoding apparatus of FIG. 2 in the form of a bitstream. The received signal may be decoded through the entropy decoder 210. For example, the entropy decoder 210 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. For example, especially when applied to VCM, the video/image information may include information indicating which AI task the encoded information is encoded for, and which network (e.g. neural network) is used to encode the encoded information, and/or information indicating for what purpose the encoded information is encoded. In an embodiment, even if the corresponding image is an image having general characteristics having a general task, network, and/or use, a value thereof shall be described.

The image decoding apparatus may further decode picture based on the information on the parameter set and/or the general constraint information. Signaled/received information and/or syntax elements described in the present disclosure may be decoded through the decoding procedure and obtained from the bitstream. For example, the entropy decoder 210 decodes the information in the bitstream based on a coding method such as exponential Golomb coding, CAVLC, or CABAC, and output values of syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a neighboring block and a decoding target block or information of a symbol/bin decoded in a previous stage, and perform arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 210 may be provided to the prediction unit (the inter prediction unit 260 and the intra prediction unit 265), and the residual value on which the entropy decoding was performed in the entropy decoder 210, that is, the quantized transform coefficients and related parameter information, may be input to the dequantizer 220. In addition, information on filtering among information decoded by the entropy decoder 210 may be provided to the filter 240. Meanwhile, a receiver (not shown) for receiving a signal output from the image encoding apparatus may be further configured as an internal/external element of the image decoding apparatus 200, or the receiver may be a component of the entropy decoder 210.

Meanwhile, the image decoding apparatus according to the present disclosure may be referred to as a video/image/picture decoding apparatus. The image decoding apparatus may be classified into an information decoder (video/image/picture information decoder) and a sample decoder (video/image/picture sample decoder). The information decoder may include the entropy decoder 210. The sample decoder may include at least one of the dequantizer 220, the inverse transformer 230, the adder 235, the filter 240, the memory 250, the inter prediction unit 260 or the intra prediction unit 265.

The dequantizer 220 may dequantize the quantized transform coefficients and output the transform coefficients. The dequantizer 220 may rearrange the quantized transform coefficients in the form of a two-dimensional block. In this case, the rearrangement may be performed based on the coefficient scanning order performed in the image encoding apparatus. The dequantizer 220 may perform dequantization on the quantized transform coefficients by using a quantization parameter (e.g., quantization step size information) and obtain transform coefficients.

The inverse transformer 230 may inversely transform the transform coefficients to obtain a residual signal (residual block, residual sample array).

The prediction unit may perform prediction on the current block and generate a predicted block including prediction samples for the current block. The prediction unit may determine whether intra prediction or inter prediction is applied to the current block based on the information on the prediction output from the entropy decoder 210 and may determine a specific intra/inter prediction mode (prediction technique).

It is the same as described in the prediction unit of the image encoding apparatus 100 that the prediction unit may generate the prediction signal based on various prediction methods (techniques) which will be described later.

The intra prediction unit 265 may predict the current block by referring to the samples in the current picture. The description of the intra prediction unit 185 is equally applied to the intra prediction unit 265.

The inter prediction unit 260 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter prediction unit 260 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 235 may generate a reconstructed signal (reconstructed picture, reconstructed block, reconstructed sample array) by adding the obtained residual signal to the prediction signal (predicted block, predicted sample array) output from the prediction unit (including the inter prediction unit 260 and/or the intra prediction unit 265). The description of the adder 155 is equally applicable to the adder 235. In case there is no residual for the block to be processed, such as when the skip mode is applied, the predicted block may be used as the reconstructed block. The description of the adder 155 is equally applicable to the adder 235. The adder 235 may be called a reconstructor or a reconstructed block generator. The generated reconstructed signal may be used for intra prediction of a next block to be processed in the current picture and may be used for inter prediction of a next picture through filtering as described below.

The filter 240 may improve subjective/objective image quality by applying filtering to the reconstructed signal. For example, the filter 240 may generate a modified reconstructed picture by applying various filtering methods to the reconstructed picture and store the modified reconstructed picture in the memory 250, specifically, a DPB of the memory 250. The various filtering methods may include, for example, deblocking filtering, a sample adaptive offset, an adaptive loop filter, a bilateral filter, and the like.

The (modified) reconstructed picture stored in the DPB of the memory 250 may be used as a reference picture in the inter prediction unit 260. The memory 250 may store the motion information of the block from which the motion information in the current picture is derived (or decoded) and/or the motion information of the blocks in the picture that have already been reconstructed. The stored motion information may be transmitted to the inter prediction unit 260 so as to be utilized as the motion information of the spatial neighboring block or the motion information of the temporal neighboring block. The memory 250 may store reconstructed samples of reconstructed blocks in the current picture and transfer the reconstructed samples to the intra prediction unit 265.

In the present disclosure, the embodiments described in the filter 160, the inter prediction unit 180, and the intra prediction unit 185 of the image encoding apparatus 100 may be equally or correspondingly applied to the filter 240, the inter prediction unit 260, and the intra prediction unit 265 of the image decoding apparatus 200.

### General Image/Video Coding Procedure

In image/video coding, a picture configuring an image/video may be encoded/decoded according to a decoding order. A picture order corresponding to an output order of the decoded picture may be set differently from the decoding order, and, based on this, not only forward prediction but also backward prediction may be performed during inter prediction.

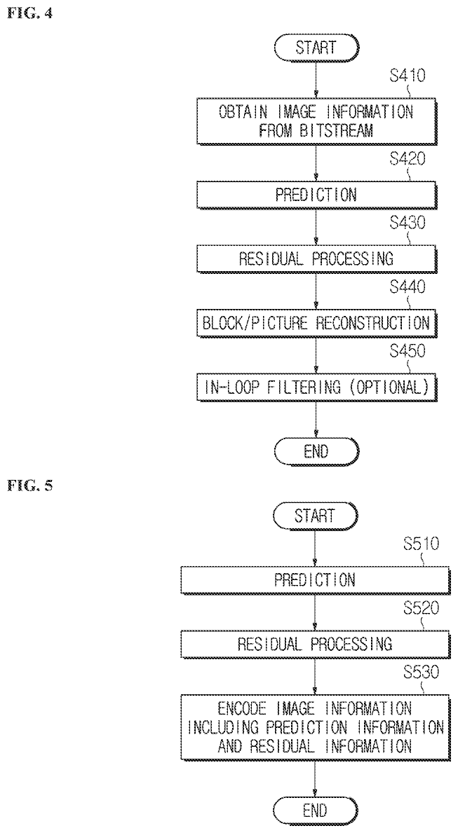

FIG. 4 is a flowchart schematically illustrating a picture decoding procedure, to which embodiments of the present disclosure are applicable. In FIG. 4, S410 may be performed in the entropy decoder 210 of the decoding apparatus described above with reference to FIG. 3, S420 may be performed in a prediction unit including the intra prediction unit 265 and the inter prediction unit 260, S430 may be performed in a residual processor including the dequantizer 220 and the inverse transformer 230. S440 may be performed in the adder 235, and S450 may be performed in the filter 240. S410 may include the information decoding procedure described in the present disclosure, S420 may include the inter/intra prediction procedure described in the present disclosure. S430 may include a residual processing procedure described in the present disclosure, S440 may include the block/picture reconstruction procedure described in the present disclosure, and S450 may include the in-loop filtering procedure described in the present disclosure.

Referring to FIG. 4, the picture decoding procedure may schematically include a procedure for obtaining image/video information (through decoding) from a bitstream (S410), a picture reconstruction procedure (S420 to S440) and an in-loop filtering procedure for a reconstructed picture (S450), as described above with reference to FIG. 3. The picture reconstruction procedure may be performed based on prediction samples and residual samples obtained through inter/intra prediction (S420) and residual processing (S430) (dequantization and inverse transform of the quantized transform coefficient) described in the present disclosure. A modified reconstructed picture may be generated through the in-loop filtering procedure for the reconstructed picture generated through the picture reconstruction procedure, the modified reconstructed picture may be output as a decoded picture, stored in a decoded picture buffer or memory 250 of the decoding apparatus and used as a reference picture in the inter prediction procedure when decoding the picture later. In some cases, the in-loop filtering procedure may be omitted. In this case, the reconstructed picture may be output as a decoded picture, stored in a decoded picture buffer or memory 250 of the decoding apparatus, and used as a reference picture in the inter prediction procedure when decoding the picture later. The in-loop filtering procedure (S450) may include a deblocking filtering procedure, a sample adaptive offset (SAO) procedure, an adaptive loop filter (ALF) procedure and/or a bi-lateral filter procedure, as described above, some or all of which may be omitted. In addition, one or some of the deblocking filtering procedure, the sample adaptive offset (SAO) procedure, the adaptive loop filter (ALF) procedure and/or the bi-lateral filter procedure may be sequentially applied or all of them may be sequentially applied. For example, after the deblocking filtering procedure is applied to the reconstructed picture, the SAO procedure may be performed. Alternatively, for example, after the deblocking filtering procedure is applied to the reconstructed picture, the ALF procedure may be performed. This may be similarly performed even in the encoding apparatus.

FIG. 5 is a flowchart schematically illustrating a picture encoding procedure, to which embodiments of the present disclosure are applicable. In FIG. 5, S510 may be performed in the prediction unit including the intra prediction unit 185 or inter prediction unit 180 of the encoding apparatus described above with reference to FIG. 2, S520 may be performed in a residual processor including the transformer 120 and/or the quantizer 130, and S530 may be performed in the entropy encoder 190. S510 may include the inter/intra prediction procedure described in the present disclosure. S520 may include the residual processing procedure described in the present disclosure, and S530 may include the information encoding procedure described in the present disclosure.

Referring to FIG. 5, the picture encoding procedure may schematically include not only a procedure for encoding and outputting information for picture reconstruction (e.g., prediction information, residual information, partitioning information, etc.) in the form of a bitstream but also a procedure for generating a reconstructed picture for a current picture and a procedure (optional) for applying in-loop filtering to a reconstructed picture, as described with respect to FIG. 2. The encoding apparatus may derive (modified) residual samples from a quantized transform coefficient through the dequantizer 140 and the inverse transformer 150, and generate the reconstructed picture based on the prediction samples, which are output of S510, and the (modified) residual samples. The reconstructed picture generated in this way may be equal to the reconstructed picture generated in the decoding apparatus. The modified reconstructed picture may be generated through the in-loop filtering procedure for the reconstructed picture, may be stored in the decoded picture buffer or memory 170, and may be used as a reference picture in the inter prediction procedure when encoding the picture later, similarly to the decoding apparatus. As described above, in some cases, some or all of the in-loop filtering procedure may be omitted. When the in-loop filtering procedure is performed, (in-loop) filtering related information (parameter) may be encoded in the entropy encoder 190 and output in the form of a bitstream, and the decoding apparatus may perform the in-loop filtering procedure using the same method as the encoding apparatus based on the filtering related information.

Through such an in-loop filtering procedure, noise occurring during image/video coding, such as blocking artifact and ringing artifact, may be reduced and subjective/objective visual quality may be improved. In addition, by performing the in-loop filtering procedure in both the encoding apparatus and the decoding apparatus, the encoding apparatus and the decoding apparatus may derive the same prediction result, picture coding reliability may be increased and the amount of data to be transmitted for picture coding may be reduced.

As described above, the picture reconstruction procedure may be performed not only in the decoding apparatus but also in the encoding apparatus. A reconstructed block may be generated based on intra prediction/inter prediction in units of blocks, and a reconstructed picture including reconstructed blocks may be generated. When a current picture/slice/tile group is an I picture/slice/tile group, blocks included in the current picture/slice/tile group may be reconstructed based on only intra prediction. Meanwhile, when the current picture/slice/tile group is a P or B picture/slice/tile group, blocks included in the current picture/slice/tile group may be reconstructed based on intra prediction or inter prediction. In this case, inter prediction may be applied to some blocks in the current picture/slice/tile group and intra prediction may be applied to the remaining blocks. The color component of the picture may include a luma component and a chroma component and the methods and embodiments of the present disclosure are applicable to the luma component and the chroma component unless explicitly limited in the present disclosure.

### Overview of Transform/Inverse Transform

As described above, the encoding apparatus may derive a residual block (residual samples) based on a block (prediction blocks) predicted through intra/inter/IBC prediction, and derive quantized transform coefficients by applying transform and quantization to the derived residual samples. Information on the quantized transform coefficients (residual information) may be included and encoded in a residual coding syntax and output in the form of a bitstream. The decoding apparatus may obtain and decode information on the quantized transform coefficients (residual information) from the bitstream to derive quantized transform coefficients. The decoding apparatus may derive residual samples through dequantization/inverse transform based on the quantized transform coefficients. As described above, at least one of quantization/dequantization and/or transform/inverse transform may be skipped. When transform/inverse transform is skipped, the transform coefficient may be referred to as a coefficient or a residual coefficient or may still be referred to a transform coefficient for uniformity of expression. Whether transform/inverse transform is skipped may be signaled based on transform_skip_flag.

Transform/inverse transform may be performed based on transform kernel(s). For example, according to the present disclosure, a multiple transform selection (MTS) scheme is applicable. In this case, some of a plurality of transform kernel sets may be selected and applied to a current block. A transform kernel may be referred to as various terms such as a transform matrix or a transform type. For example, the transform kernel set may indicate a combination of a vertical-direction transform kernel (vertical transform kernel) and a horizontal-direction transform kernel (horizontal transform kernel).

For example, MTS index information (or tu_mts_idx syntax element) may be generated/encoded in the encoding apparatus and signaled to the decoding apparatus to indicate one of the transform kernel sets.

The transform kernel set may be determined based on, for example, cu_sbt_horizontal_flag and cu_sbt_pos_flag. Alternatively, the transform kernel set may be determined based on, for example, the intra prediction mode for the current block.

In the present disclosure, the MTS-based transform is applied as a primary transform, and a secondary transform may be further applied. The secondary transform may be applied only to coefficients in the top left w×h region of the coefficient block to which the primary transform is applied, and may be called reduced secondary transform (RST). For example, w and/or h may be 4 or 8. In transform, the primary transform and the secondary transform may be sequentially applied to the residual block, and in the inverse transform, the inverse secondary transform and the inverse primary transform may be sequentially applied to the transform coefficients. The secondary transform (RST transform) may be called low frequency coefficients transform (LFCT) or low frequency non-separable transform (LFNST). The inverse quadratic transform may be called inverse LFCT or inverse LFNST.

Transform/inverse transform may be performed in units of CU or TU. That is, transform/inverse transform is applicable to residual samples in a CU or residual samples in a TU. A CU size may be equal to a TU size or a plurality of TUs may be present in a CU region. Meanwhile, the CU size may generally indicate a luma component (sample) CB size. The TU size may generally indicate a luma component (sample) TB size. A chroma component (sample) CB or TB size may be derived based on the luma component (sample) CB or TB size according to a component ratio according to a color format (chroma format) (e.g., 4:4:4, 4:2:2, 4:2:0, etc.). The TU size may be derived based on maxTbSize. For example, when the CU size is greater than maxTbSize, a plurality of TUs (TBs) of maxTbSize may be derived from the CU and transform/inverse transform may be performed in units of TU (TB), maxTbSize may be considered to determine whether to apply various intra prediction types such as ISP. Information on maxTbSize may be predetermined or may be generated and encoded in the encoding apparatus and signaled to the encoding apparatus.

### Example of Coding Layer and Structure

A coded video/image according to the present disclosure may be processed, for example, according to a coding layer and structure which will be described below.

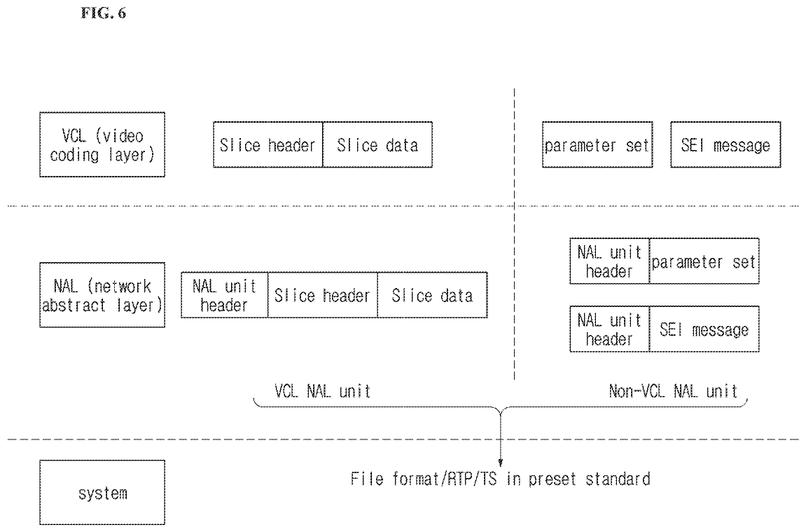

FIG. 6 is a view showing a hierarchical structure for a coded image.

Referring to FIG. 6, the coded image may be classified into a video coding layer (VCL) for an image decoding process and handling itself, a low-level system for transmitting and storing encoded information, and a network abstraction layer (NAL) present between the VCL and the low-level system and responsible for a network adaptation function.

In the VCL. VCL data including compressed image data (slice data) may be generated or a supplemental enhancement information (SEI) message additionally required for a decoding process of an image or a parameter set including information such as a picture parameter set (PPS), a sequence parameter set (SPS) or a video parameter set (VPS) may be generated. In the above information/message, task information capable of being performed through an encoded image and additional information on an image, such as a method of generating an encoding target image, may be described as a syntax element according to a predetermined syntax table.

In the NAL, header information (NAL unit header) may be added to a raw byte sequence payload (RBSP) generated in the VCL to generate an NAL unit. In this case, the RBSP refers to slice data, a parameter set, an SEI message generated in the VCL. The NAL unit header may include NAL unit type information specified according to RBSP data included in a corresponding NAL unit.

As shown in the figure, the NAL unit may be classified into a VCL NAL unit and a non-VCL NAL unit according to the RBSP generated in the VCL. The VCL NAL unit may mean a NAL unit including information on an image (slice data), and the Non-VCL NAL unit may mean a NAL unit including information (parameter set or SEI message) required to decode an image. According to an embodiment, information indicating that the encoded image is image information for performing a specific task may be included in the VCL NAL unit. Alternatively, information indicating that the encoded image is image information for performing a specific task may be included in the non-VCL NAL unit.

The VCL NAL unit and the Non-VCL NAL unit may be attached with header information and transmitted through a network according to the data standard of the low-level system. For example, the NAL unit may be modified into a data format of a predetermined standard, such as H.266NVC file format, RTP (Real-time Transport Protocol) or TS (Transport Stream), and transmitted through various networks.

As described above, in the NAL unit, a NAL unit type may be specified according to the RBSP data structure included in the corresponding NAL unit, and information on the NAL unit type may be stored in a NAL unit header and signalled.

For example, this may be largely classified into a VCL NAL unit type and a non-VCL NAL unit type depending on whether the NAL unit includes information on an image (slice data). The VCL NAL unit type may be classified according to the property and type of the picture included in the VCL NAL unit, and the Non-VCL NAL unit type may be classified according to the type of a parameter set.

An example of the NAL unit type specified according to the type of the parameter set/information included in the Non-VCL NAL unit type will be listed below.
DCI (Decoding capability information) NAL unit: Type for NAL unit including DCI
VPS (Video Parameter Set) NAL unit: Type for NAL unit including VPS
SPS (Sequence Parameter Set) NAL unit: Type for NAL unit including SPS
PPS (Picture Parameter Set) NAL unit: Type for NAL unit including PPS
APS (Adaptation Parameter Set) NAL unit: Type for NAL unit including APS
PH (Picture header) NAL unit: Type for NAL unit including PH

The above-described NAL unit types may have syntax information for a NAL unit type, and the syntax information may be stored in a NAL unit header and signalled. For example, the syntax information may be nal_unit_type, and the NAL unit types may be specified as nal_unit_type values.

Meanwhile, as described above, one picture may include a plurality of slices, and one slice may include a slice header and slice data. In this case, one picture header may be further added to a plurality of slices (a slice header and a slice data set) in one picture. The picture header (picture header syntax) may include information/parameters commonly applicable to the picture.

The slice header (slice header syntax) may include information/parameters commonly applicable to the slice. The APS (APS syntax) or PPS (PPS syntax) may include information/parameters commonly applicable to one or more slices or pictures. The SPS (SPS syntax) may include information/parameters commonly applicable to one or more sequences. The VPS (VPS syntax) may include information/parameters commonly applicable to multiple layers. The DCI (DCI syntax) may include information/parameters commonly applicable to overall video. The DCI may include information/parameters related to decoding capability. In the present disclosure, high level syntax (HLS) may include at least one of the APS syntax, the PPS syntax, the SPS syntax, the VPS syntax, the DCI syntax, the picture header syntax or the slice header syntax. Meanwhile, in the present disclosure, low level syntax (LLS) may include, for example, slice data syntax, CTU syntax, coding unit syntax, transform unit syntax, etc.

In the present disclosure, image/video information encoded in the encoding apparatus and signalled to the decoding apparatus in the form of a bitstream may include not only in-picture partitioning related information, intra/inter prediction information, residual information, in-loop filtering information but also information on the slice header, information on the APS, information on the PPS, information on the SPS, information on the VPS and/or information on the DCI. In addition, the image/video information may further include general constraint information and/or information on a NAL unit header.

### Overview of VCM

VCM (Video/image coding for machines) means encoding/decoding all or a part of a video source and/or information necessary for the video source according to a request of a user and/or a machine, a purpose, and a surrounding environment.

VCM technology may be used in a variety of application fields. For example, VCM technology may be used in the fields of surveillance system, intelligent transportation, smart city, intelligent industry, intelligent content. In a surveillance system that recognizes and tracks an object or a person, VCM technology may be used to transmit or store information obtained from a surveillance camera. In addition, in a smart traffic system related to intelligent transportation, VCM technology may be used to transmit vehicle location information collected from a GPS, various sensing information collected from LIDAR, radar, etc. and vehicle control information to other vehicles or infrastructure. Also, in the field of smart cities for monitoring traffic conditions and allocating resources, VCM technology may be used to transmit information necessary to perform individual tasks of (interconnected) sensor nodes and devices.

In VCM, an encoding/decoding target may be referred to as a feature. A feature may refer to a data set containing time series information extracted/processed from a video source. The feature may have separate information types and properties that are different from the video source, and may be reconfigured to suit a specific task depending on the embodiment. Accordingly, the compression method or expression format of the feature may be different from that of the video source.

The present disclosure provides various embodiments related to a feature encoding/decoding method, and, unless otherwise specified, the embodiments of the present disclosure may be performed individually or in combination of two or more. Hereinafter, embodiments of the present disclosure will be described in detail with reference to the accompanying drawings.

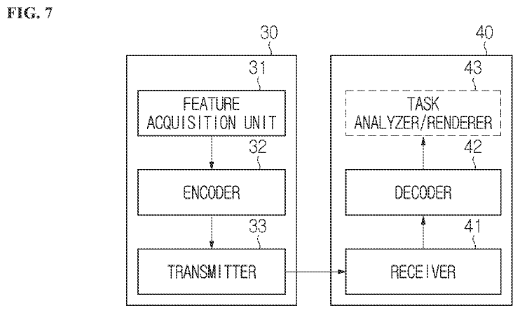

FIG. 7 is a view schematically illustrating a VCM system to which embodiments of the present disclosure are applicable.

Referring to FIG. 7, the VCM system may include an encoding apparatus 30 and a decoding apparatus 40.

The encoding apparatus 30 may compress/encode a feature/feature map extracted from a source image/video to generate a bitstream, and transmit the generated bitstream to the decoding apparatus 40 through a storage medium or network.

The encoding apparatus 30 may include a feature acquisition unit 31, an encoder 32 and a transmitter 33.

The feature acquisition unit 31 may obtain a feature/feature map for a source image/video. In some embodiments, the feature acquisition unit 31 may obtain a feature/feature map previously extracted from an external device, for example, a feature extraction network. In this case, the feature acquisition unit 31 performs a feature signaling interface function. In contrast, the feature acquisition unit 31 may obtain a feature/feature map by executing a neural network (e.g., CNN, DNN, etc.) using a source image/video as input. In this case, the feature acquisition unit 31 performs a feature extraction network function.

Meanwhile, although not shown, the encoding apparatus 30 may further include a source image generator for obtaining a source image/video. The source image generator may be implemented with an image sensor, a camera module, etc., and may obtain the source image/video through the capture, synthesis, or generation process of the image/video. The source image/video generated by the source image generator may be transmitted to the feature extraction network and used as input information for extracting the feature/feature map.

The encoder 32 may encode the feature/feature map obtained by the feature acquisition unit 31. The encoder 32 may perform a series of procedures such as prediction, transform, and quantization, in order to improve coding efficiency. In addition, the encoded data (e.g., feature information) may be output in the form of a bitstream. In the present disclosure, a bitstream including feature information may be referred to as a VCM bitstream.

The transmitter 33 may transmit the bitstream to the decoding apparatus 40 in the form of a file through a digital storage medium. The digital storage medium may include a variety of storage media such as USB, SD, CD, DVD, Blu-ray, HDD, and SSD. The transmitter 33 may include an element for generating a media file having a predetermined file format. Alternatively, the transmitter 33 may transmit the encoded feature information to the decoding apparatus 40 in the form of a streaming form through a network. The network may include a wired/wireless communication network such as the Internet, a local area network (LAN), and a wide LAN (WLAN). The transmitter 33 may include an element for transmitting the encoded feature information through a broadcast/communication network.

The decoding apparatus 40 may obtain feature information from the encoding apparatus 30 and reconstruct the feature/feature map based on the obtained feature information.

The decoding apparatus 40 may include a receiver 41 and a decoder 42. In addition, in some embodiments, the decoding apparatus 40 may further include a task analyzer/renderer 43.

The receiver 41 may receive a bitstream from the encoding apparatus 30, obtain feature information from the received bitstream and forward it to the decoder 42.

The decoder 42 may decode the feature/feature map based on the obtained feature information. The decoder 42 may perform a series of procedures such as dequantization, inverse transform, and prediction corresponding to the operation of the encoder 32, in order to improve decoding efficiency.

The task analyzer/renderer 43 may perform a task analysis and rendering process using the decoded feature, thereby performing a predetermined task (e.g., computer vision tasks such as face recognition, behavior recognition, lane recognition, etc.). In some embodiments, the task analyzer/renderer 43 may be implemented outside the decoding apparatus 40. In this case, the decoded feature may be forwarded to the task analyzer/renderer 43 through a feature signaling interface and used to perform a predetermined task.

In this way, the VCM system may encode/decode the feature extracted from the source image/video according to the request of the user and/or the machine, the task purpose, and the surrounding environment, and perform various machine-oriented tasks using the feature. In an example, the VCM system may be implemented by extending/redesigning the video/image coding system described above with reference to FIG. 1, and may perform various encoding/decoding methods defined in the VCM (Video Coding for Machines) standard.

Meanwhile, in the VCM system, the feature/feature map may be generated in each hidden layer of the neural network. At this time, the size of the feature map and the number of channels may vary depending on the type of neural network or the location of the hidden layer. In the present disclosure, the feature map may be referred to as a feature set.

Embodiments of the present disclosure provide encoding/decoding methods necessary to compress/reconstruct the feature/feature map generated in the hidden layer of a neural network, for example, a Convolutional Neural Network (CNN) or a Deep Neural Network (DNN).

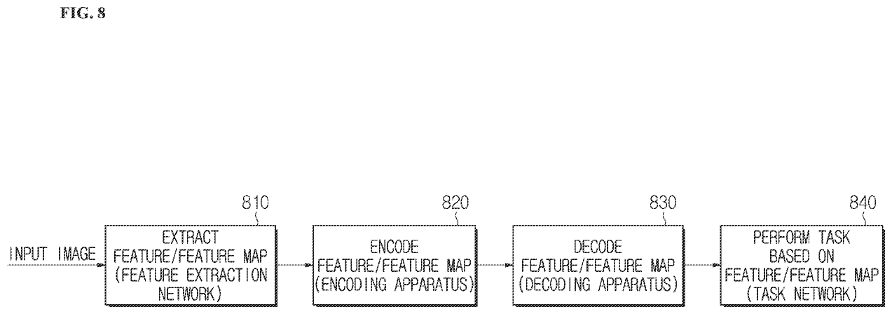

FIG. 8 is a diagram illustrating an example of a VCM pipeline applicable to embodiments of the present disclosure.

Referring to FIG. 8, the VCM pipeline may include a first stage 810 for extracting a feature/feature map from an input image, a second stage 820 for encoding the extracted feature/feature map, a third stage 830 for decoding the encoded feature/feature map, and a fourth stage 840 for performing a predetermined task (e.g., machine task or machine/human vision hybrid task, etc.) based on the decoded feature/feature map.

The first stage 810 may be implemented by a feature extraction network, such as a CNN or DNN. The feature extraction network may refer to a set of continuous hidden layers from the input of a neural network, and a feature/feature map may be extracted by performing a predetermined neural network operation on an input image.

The second stage 820 may be executed by a feature encoding apparatus. The feature encoding apparatus may generate a bitstream by compressing/encoding the feature/feature map extracted in the first stage 810. The feature encoding apparatus may basically have the same/similar structure as the image encoding apparatus 200 described above with reference to FIG. 2, except that the target of compression/encoding is a feature/feature map rather than a video/image

The third stage 830 may be executed by a feature decoding apparatus. The feature decoding apparatus may decode/reconstruct a feature/feature map from the bitstream generated in the second stage 820. Like the feature encoding apparatus, the feature decoding apparatus may basically have the same/similar structure as the image decoding apparatus 300 described above with reference to FIG. 3, except that the target of decoding/reconstruction is a feature/feature map rather than a video/image.

The fourth stage 840 may be executed by a task network. The task network may perform a predetermined task based on the feature/feature map reconstructed in the third stage 830. Here, the task may be a machine task such as object detection, or a hybrid task that is a combination of machine tasks and human vision. The task network may perform task analysis and feature/feature map rendering to perform tasks.

FIGS. 9 to 11 are diagrams illustrating operation of a feature extraction network.

FIG. 9 illustrates an example of input/output of a feature extraction network.

First, referring to FIG. 9, the feature extraction network 900 may extract a feature map (or feature set) from an input source. In FIG. 9, W, H, and C may mean the width, height, and number of channels of the input source, respectively. If the input source is an RGB image, the number C of channels of the input source may be 3. In addition, W′, H′, and C′ may mean the width, height, and number of channels of a feature map, which are output values, respectively. The number C of channels' of the feature map may vary depending on the feature extraction method, and may generally be larger than the number C of channels of the input source.

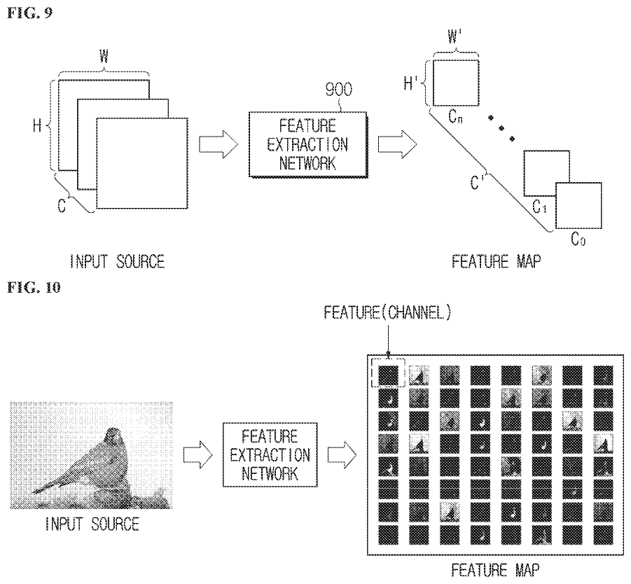

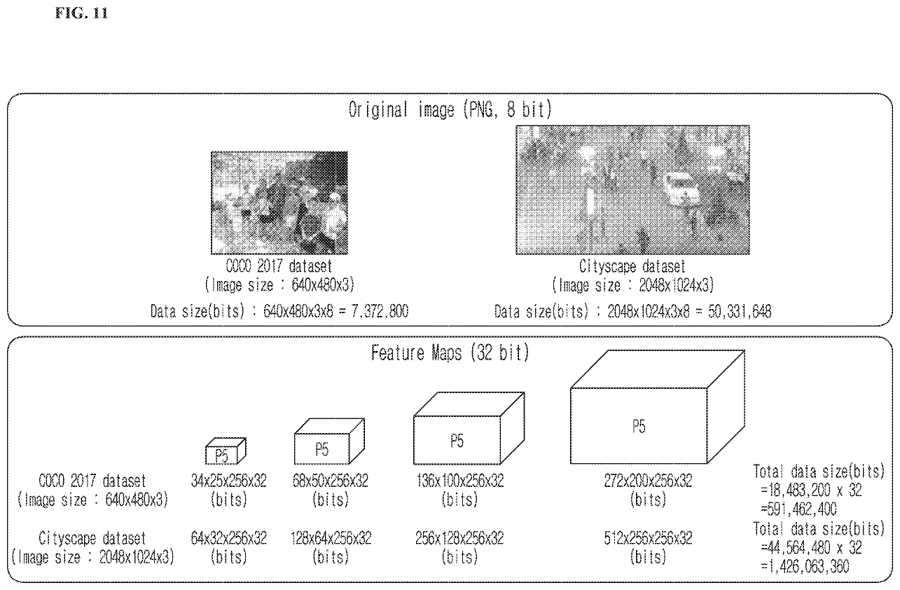

FIG. 10 illustrates an example of extracting 64 features (or channels) from a single input source. Referring to FIG. 10, the size of each feature (or channel) output from a feature extraction network may be less than that of the input source. However, since the number of channels of the feature map is greater than the number of channels of the input source, the total size of the feature map may be greater than the size of the input source. Accordingly, as shown in FIG. 11, the amount of data of the feature map output from the feature extraction network may be significantly greater than the amount of data of the input source and as a result, encoding/decoding performance and complexity may be greatly reduced.

To solve this problem, embodiments of the present disclosure provide a method of efficiently reducing the size of a feature map. Specifically, embodiments of the present disclosure include i) a method of projecting a high-dimensional feature into a low dimension through feature transform, ii) a method of generating/managing a transform matrix for low-dimensional projection, and iii) a method of reconstructing a feature projected into a low dimension back into a high dimension.

### Embodiment 1

Embodiment 1 of the present disclosure relates to a method of reducing the dimension of a feature map obtained from a source image/video. Specifically, according to Embodiment 1 of the present disclosure, the dimension of the feature map may be reduced by projecting a high-dimensional feature map into a low dimension through feature transform. Here, the dimension of the feature map may mean the number of channels of the feature map described above with reference to FIGS. 9 to 11. In one embodiment, feature transform may be performed based on a dimensionality reduction technique, such as Principle Component Analysis (PCA).

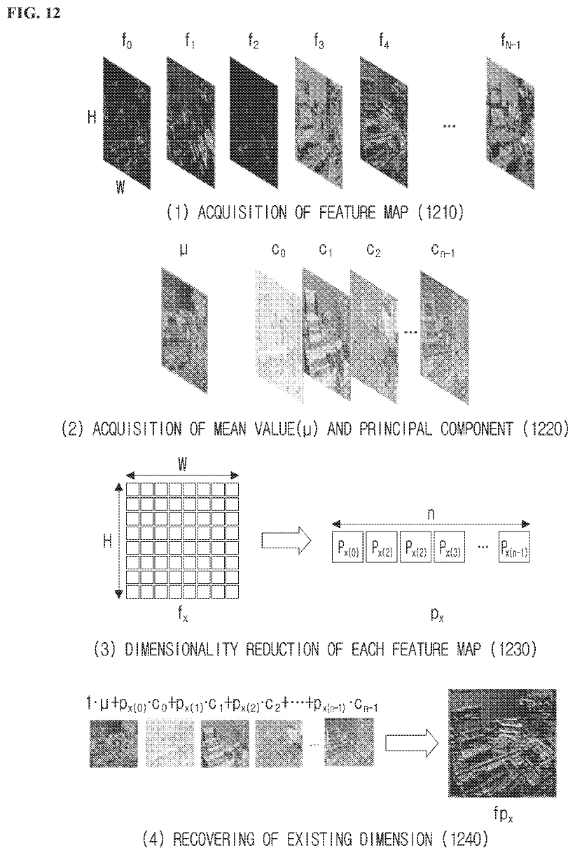

FIG. 12 is a diagram illustrating a PCA based feature transform process.

Referring to FIG. 12, by executing a neural network operation using a source image/video as input, a feature map including N channels f₀ to f_{N-1} each having a size of W×H may be obtained (1210).

Then, principal components C₀ to Cₙ₋₁ may be obtained by performing a PCA operation on the obtained feature maps f₀ to f_{N-1} (1220). For example, by obtaining a mean value μ of collocated pixel values at each pixel location in the feature map, subtracting the mean value μ at that location from the pixel value of each pixel, and then performing principal component analysis, n principal components C₀ to Cₙ₋₁ may be obtained. At this time, as the number n of principal components C₀ to Cₙ₋₁ increases, the dimensionality reduction effect of the feature map may decrease. However, in this case, since the data after dimensionality reduction more accurately reflects the variance of original data, feature map-based task performance can be further improved.

Arbitrary feature map data fx expressed by W×H pixels may be projected onto the principal component Cx and expressed as n coefficient values Pₓ₍₀₎ to Pₓ₍ₙ₋₁₎ (1230). At this time, n may be greater than or equal to 1 and less than or equal to W×H. Accordingly, feature map data fx with a W×H dimension may be transformed into n-dimensional data.

Meanwhile, in order to reconstruct the feature map data fx transformed into the n-dimensional data, not only the above-described mean value μ and the principal component Cx, but also a predetermined projection matrix (e.g., eigenvector, transform matrix, etc.) may be used (1240). This is because the DCT transform technique, widely used in video codecs, is independent of the input data, while dimensionality reduction techniques such as PCA generate a transform matrix based on the covariance of the input data. In other words, since the transform matrix for PCA is dependent on the input data, a transform matrix should be generated/managed for each input data, and as a result, there is a problem that coding efficiency may decrease and complexity may increase.

To solve this problem, according to Embodiment 1 of the present disclosure, feature transform may be performed based on a global dimensionality reduction technique that is not dependent on input data. To this end, a feature data set for generating a transform matrix may be constructed from a predetermined input data set including a video/image. In the present disclosure, the transform matrix may be referred to as a feature transform matrix.

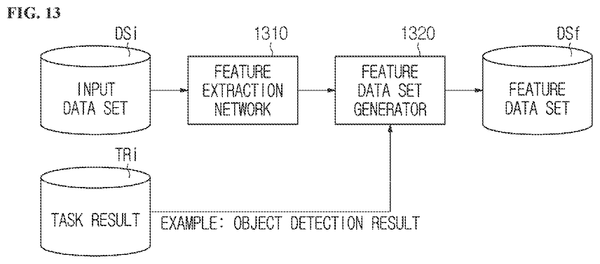

FIGS. 13 to 15 are diagrams illustrating a feature data set construction method according to an embodiment of the present disclosure.

FIG. 13 schematically shows a method of constructing a feature data set.

Referring to FIG. 13, a feature extraction network 1310 may extract a feature map including a plurality of features from an input data set DSi. In addition, a feature data set generator 1320 may construct a feature data set DSf by processing the extracted feature map into a form available for learning. In one embodiment, the feature data set generator 1320 may construct the feature data set DSf by selecting only features necessary to perform a specific task based on a task result TRi.

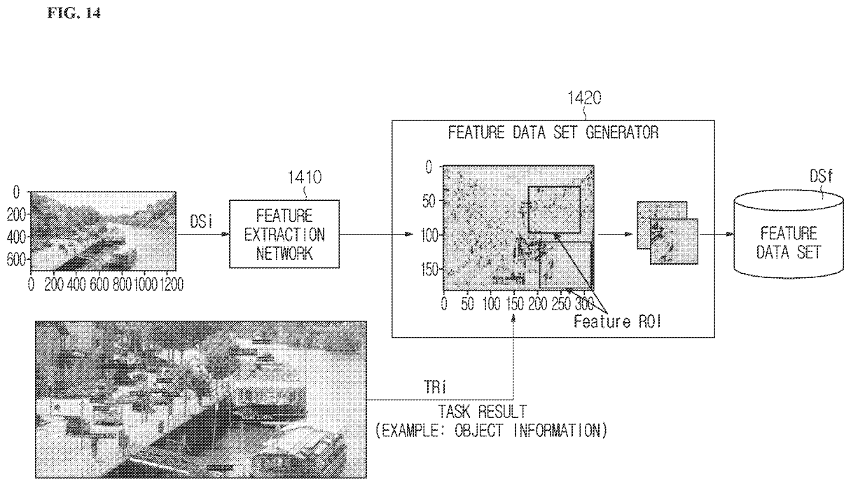

FIG. 14 shows in detail a method of selecting features and constructing a feature data set.

Referring to FIG. 14, a feature data set generator 1420 may construct (or generate) a feature data set DSf based on an input data set DSi and label information TRi. Here, label information TRi may mean a result of performing a specific task (i.e., task result) using the input data set DSi. For example, if the specific task is an object detection task, the label information TRi may include information about a region of interest (ROI), which is a region where the detected object in the image exists.

The feature data set generator 1420 may construct the feature data set DSf by selecting some features from the feature map extracted from the input data set DSi based on the label information TRi. For example, the feature data set generator 1420 may construct the feature data set DSf using only the features of the ROI. Meanwhile, unlike shown in FIG. 14, when the label information TRi of the input data set DSi is not provided, the feature data set generator 1420 may construct the feature data set DSf by selecting some features in the feature map based on the distribution characteristics or importance of the features.

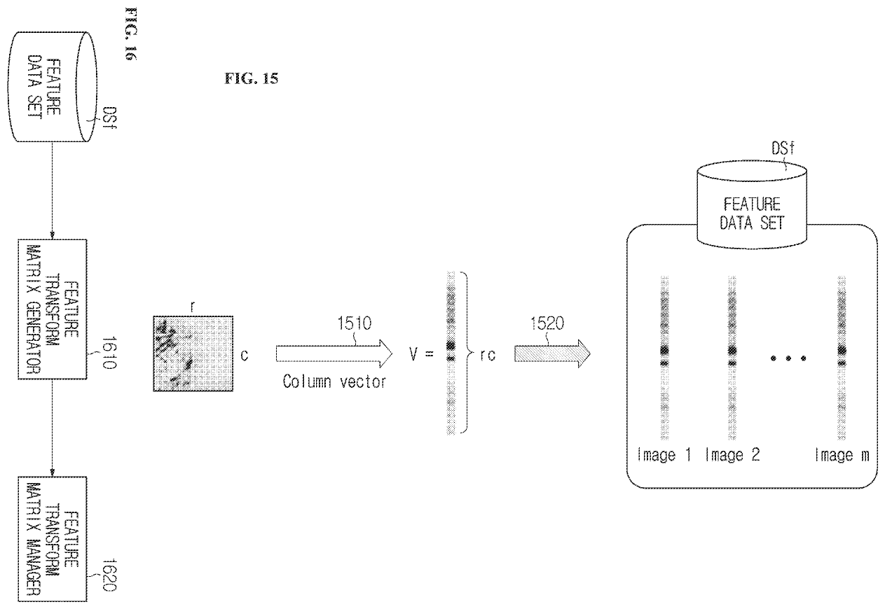

FIG. 15 shows in detail a method of constructing a feature data set by processing features.

Referring to FIG. 15, a feature data set generator may construct a feature data set DSf by processing features obtained from an input data set DSi into a form that is easy to learn. For example, the feature data set generator transforms a two-dimensional feature with a width of r and a height of c into a one-dimensional column vector with a size of r·c (1510) and inputs it to the feature data set DSf (1520).

In this way, the feature data set generator may select some features from the feature map, process the selected features, and input them to the feature data set DSf. Meanwhile, in some embodiments, at least some of the selection process of FIG. 14 and the processing process of FIG. 15 may be skipped. For example, the feature data set generator may select some features from the feature map and input the selected features to the feature data set DSf without a separate processing process. In addition, the feature data set generator may process all features of the feature map without a separate selection process and input them to the feature data set DSf. In addition, the feature data set generator may input all features of the feature map to the feature data set DSf without separate selection and processing processes.

In addition, the generated feature data set DSf may be used as training data to generate a feature transform matrix.

FIGS. 16 to 18 are diagrams illustrating a feature transform matrix generation method according to an embodiment of the present disclosure.

FIG. 16 schematically shows a method of generating a feature transform matrix by performing feature transform training.

Referring to FIG. 16, a feature transform matrix generator 1610 performs feature transform training using a feature data set DSf to generate a feature transform matrix (e.g., eigenvector) and matrix information (e.g., eigenvalues, applicable task types, etc.). At this time, the task type to which the feature transform matrix is applicable may vary depending on the properties of the feature data set DSf. For example, when the feature data set DSf consists only of features for performing a specific task, the feature transform matrix generated based on the feature data set may perform a function of transforming only information necessary to perform the task. Here, transform, as described above, means defining a dimension into which information necessary to perform a specific task may be projected and projecting high-dimensional feature information into a predefined low dimension. When feature transform is performed using a feature transform matrix for a specific task, information necessary for the task may be effectively projected into a predefined low dimension, and information unnecessary for the task may not be effectively projected into a predefined low dimension. In this way, the feature transform matrix may perform a mask function of feature information, and through this, unnecessary information is removed and only the information necessary to perform a specific task is encoded, thereby improving compression efficiency.

Meanwhile, the feature transform matrix and matrix information generated by the feature transform matrix generator 1610 may be maintained/managed by a feature transform matrix manager 1620. For example, the feature transform matrix manager 1620 may store the feature transform matrix and matrix information in a predetermined storage space, and provide related information to an encoder and/or decoder when requested. In some embodiments, the feature transform matrix manager 1620 may be implemented as a physical or logical entity outside the encoder and decoder. For example, the feature transform matrix manager 1620 is an external device and may be implemented using at least one hardware or software module, or a combination thereof. Additionally, in some embodiments, the feature transform matrix generator 1610 and the feature transform matrix manager 1620 may be integrated and implemented as one entity.

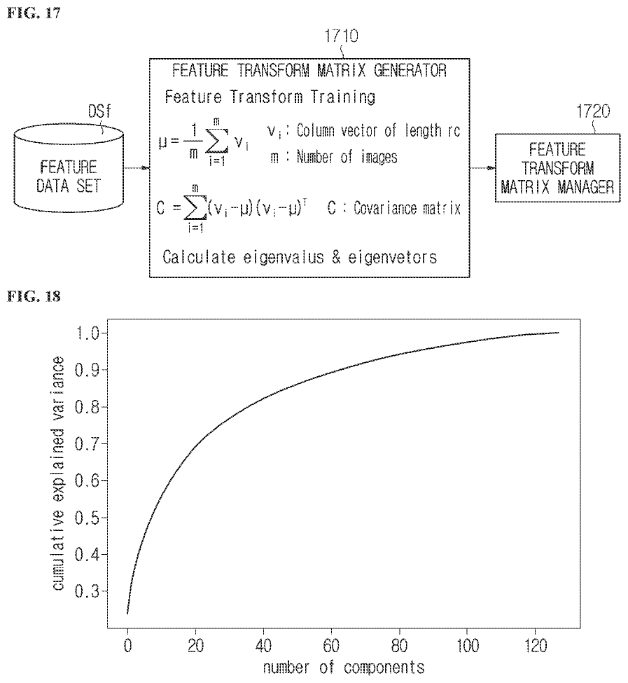

FIG. 17 shows in detail a method of performing feature transform training based on PCA.

Referring to FIG. 17, a feature transform matrix generator 1710 may obtain an mean value μ of a feature data set DSf (see Equation 1). In addition, the feature transform matrix generator 1710 may obtain a covariance matrix C based on the mean value μ of the feature data set DSf (see Equation 2). The feature transform matrix generator 1710 may generate a feature transform matrix by calculating a eigenvector and eigenvalue of the obtained covariance matrix C. At this time, the eigenvector may include information about a dimension to which feature information will be projected, and the eigenvalue may indicate the amount of information included in the eigenvector.

As the dimension to which feature information will be projected increases, information loss decreases, while the amount of information to be encoded increases (i.e., a trade-off relationship). FIG. 18 shows a variance range of original feature map data that may be expressed according to the number of principal components. Referring to FIG. 18, it can be seen that as the number of principal components increases, the cumulative variance approaches 1.0, allowing the variance of the original feature map data to be expressed more accurately. Since the variance of the original feature map data according to the number of principal components can be known through the eigenvalues, it is possible to determine an appropriate number of principal components.

The feature transform matrix generated according to Embodiment 1 of the present disclosure above may be used globally regardless of input data (e.g., video source). In this respect, the feature transform method according to Embodiment 1 of the present disclosure may be different from existing dimensionality reduction techniques that depend on input data. Accordingly, unlike existing dimensionality reduction techniques, there is no need to encode/decode the feature transform matrix for each input data, and like general transform techniques (e.g., DCT), the encoder and the decoder having the same feature transform matrix in advance are enough. As a result, encoding/decoding efficiency can be further improved.

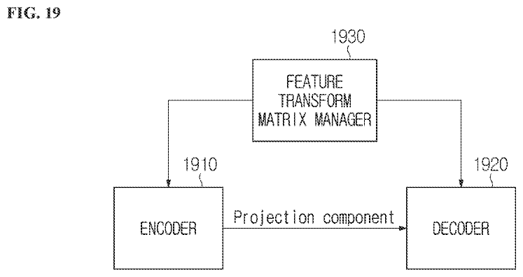

FIG. 19 is a diagram schematically illustrating an encoder/decoder structure according to an embodiment of the present disclosure.

Referring to FIG. 19, an encoder 1910 may encode a feature (or feature map) by performing feature transform based on a feature transform matrix. The feature transform matrix performs a function of reducing the dimension of the feature map, and may be a global transform matrix that is independent of input data, as described above with reference to FIGS. 16 to 18. The feature transform matrix may be generated in advance based on a predetermined feature data set and maintained/managed by a feature transform matrix manager 1930. In addition, the encoder 1910 may obtain a feature transform matrix from the feature transform matrix manager 1930 for feature transform. Accordingly, since there is no need to generate a feature transform matrix for each input data, complexity can be reduced. In addition, since there is no need to separately encode the feature transform matrix and matrix information used for feature transform, encoding/decoding efficiency can be further improved.

In one embodiment, the encoder 1910 may generate a bitstream by encoding projection component information. The projection component information may include principal components and principal component-related information generated through feature transform. At this time, the principal component-related information may include information about the size and purpose of the principal component (e.g., applicable task type, etc.). An example of a syntax structure including projection component information is shown in Table 1.

TABLE 1

```
feature_coding( ) {
  ...
  PCA_Data_coding (principal_components,
  information_of_component )
  ...
}
```

Referring to Table 1, a PCA_Data coding function including projection component information may be called within a feature coding syntax (feature_coding). At this time, the principal components (principal_components) and principal component-related information (information_of_component) may be used as a call input value of the PCA_Data coding function.

According to Embodiment 1 of the present disclosure, feature transform may be performed based on a global feature transform matrix. The global feature transform matrix may be generated in advance based on a predetermined feature data set and maintained/managed by a feature transform matrix manager. Accordingly, since the encoder and decoder do not need to separately generate/manage the feature transform matrix, complexity can be reduced and encoding/decoding efficiency can be further improved.

### Embodiment 2

As in the example of FIG. 14, when a feature data set is constructed using only features in a ROI and a feature transform matrix is generated/used based on the feature data set, transform and reconstruction performance of features in a non-ROI may deteriorate. In addition to machine tasks such as object detection, VCM may also target a hybrid task which is a combination of human vision and machine task, and in this case, essential information for human vision may be included in the non-ROI. Therefore, in order to prevent performance degradation of the hybrid task, it is necessary to generate/manage the feature transform matrix for the non-ROI separately from the feature transform matrix for the ROI.

Accordingly, according to Embodiment 2 of the present disclosure, a plurality of feature transform matrices may be used according to various conditions such as feature type, task type, and characteristics. A plurality of feature transform matrices may be generated by performing feature transform training using different feature data sets. The plurality of feature transform matrices are global transform matrices that are independent of input data, and their basic properties may be the same as those of Embodiment 1 described above with reference to FIGS. 13 to 18. Hereinafter, the feature transform matrix according to Embodiment 2 and the feature transform method using the same will be described in detail, focusing on differences from Embodiment 1.

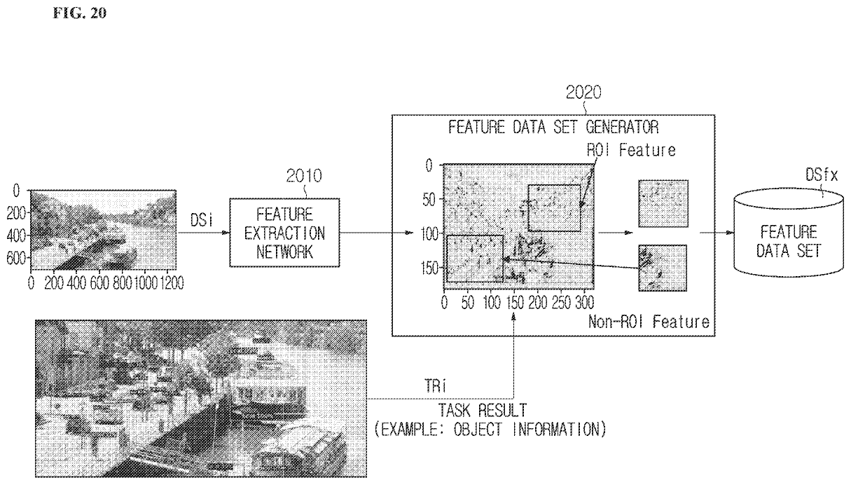

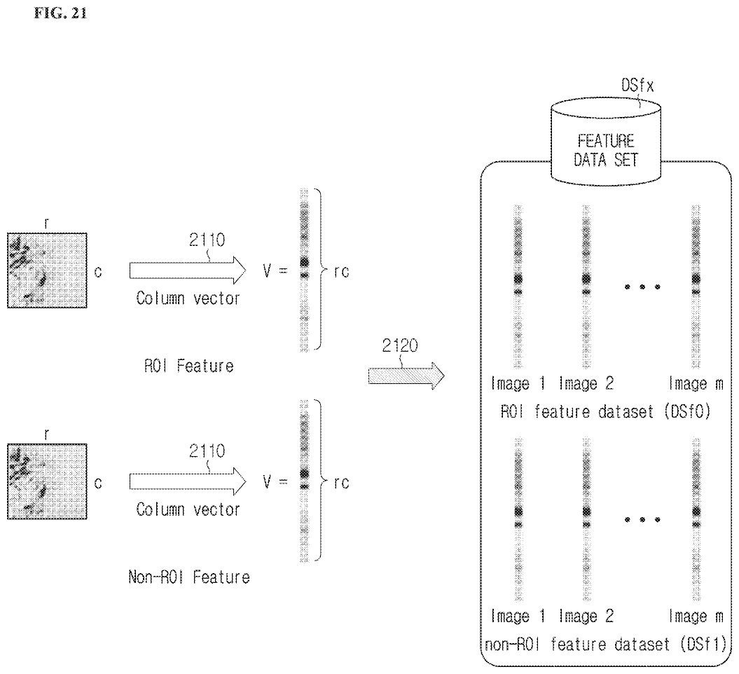

FIGS. 20 and 21 are diagrams illustrating a method of generating a feature data set according to an embodiment of the present disclosure.

FIG. 20 shows a method of constructing an individual feature data set for each of a ROI and a non-ROI.

Referring to FIG. 20, a feature data set generator 2020 may construct a feature data set DSfₓ based on an input data set DSi and label information TRi. Here, the label information TRi may mean a result of performing a specific task using the input data set DSi. Features extracted from the input data set DSi may be grouped based on the label information TRi and classified by feature type. For example, if the label information TRi includes information about a ROI and a non-ROI, features extracted from the input data set DSi may be classified into ROI features and non-ROI features. In addition, when the label information TRi includes information about a first ROI where a human face was detected, a second ROI where text was detected and a non-ROI, features extracted from the input data set DSi may be classified into a first ROI feature, a second ROI feature, and a non-ROI feature.

The feature data set generator 2020 may construct a plurality of feature data sets DSfₓ by classifying the features extracted from the input data set DSi by the above-described feature type. For example, the feature data set generator 2020 may construct an ROI feature data set using only ROI features among the features extracted by a feature extraction network 2010. In addition, the feature data set generator 2020 may construct a non-ROI feature data set using only non-ROI features among the features extracted by the feature extraction network 2010.

FIG. 21 shows a method of constructing a feature data set by processing features.

Referring to FIG. 21, a feature data set generator may process features obtained from an input data set into a form that is easy to learn by feature type (2110) (e.g., data structure change) to construct a plurality of feature data sets DSfₓ (2120). For example, the feature data set generator may construct a ROI feature data set DSf₀ by transforming two-dimensional ROI features with a width of r and a height of c into a one-dimensional column vector with a size of r·c. In addition, the feature data set generator may construct a non-ROI feature data set DSf₁ by transforming two-dimensional non-ROI features with a width of r and a height of c into a one-dimensional column vector with a size of r·c. FIG. 21 shows an example in which the ROI feature data set DSf₀ and the non-ROI feature data set DSf₁ are constructed with the same size (or number), but Embodiment 2 of the present disclosure is not limited to this. That is, in some embodiments, at least some of the plurality of feature data sets may be constructed to have different sizes.

The plurality of generated feature data sets DSfₓ may be used as training data to generate different feature transform matrices.

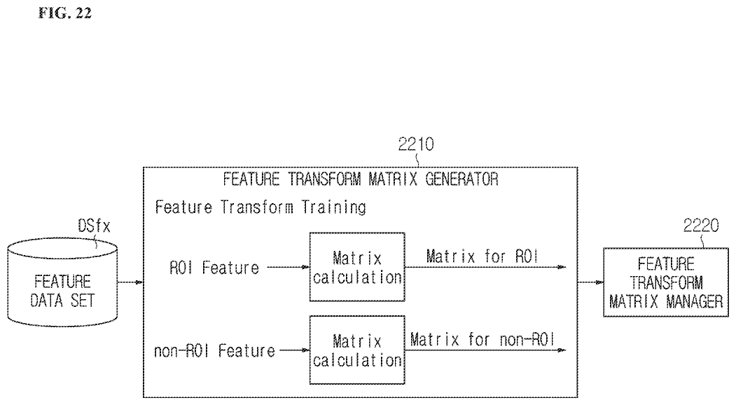

FIG. 22 is a diagram illustrating a method of generating a plurality of feature transform matrices according to an embodiment of the present disclosure. FIG. 22 schematically shows a method of generating a plurality of feature transform matrices by performing feature transform training.

Referring to FIG. 22, a feature transform matrix generator 2210 may generate a plurality of feature transform matrices and matrix information by performing feature transform training using a plurality of feature data sets DSfₓ. For example, the feature transform matrix generator 2210 may generate an ROI feature transform matrix and ROI matrix information by performing feature transform training using a ROI feature data set. In addition, the feature transform matrix generator 2210 may generate a non-ROI feature transform matrix and non-ROI matrix information by performing feature transform training using a non-ROI feature data set. Here, the matrix information may include information about the transform coefficients (e.g., eigenvectors), variance (e.g., eigenvalues), and purpose (or task type) (e.g., object detection) of each feature transform matrix.

Meanwhile, a plurality of feature transform matrices and matrix information generated by the feature transform matrix generator 2210 may be maintained/managed by a feature transform matrix manager 2220. For example, the feature transform matrix manager 2220 may store a plurality of feature transform matrices and matrix information in a predetermined storage space, and provide one of the plurality of feature transform matrices and its matrix information to an encoder and/or a decoder when requested.

The plurality of feature transform matrices generated according to Embodiment 2 of the present disclosure above may be used globally regardless of input data (e.g., video source). As a result, unlike existing dimensionality reduction techniques, since there is no need to encode/decode the feature transform matrix for each input data, encoding/decoding efficiency can be further improved. Meanwhile, according to Embodiment 2 of the present disclosure, a plurality of feature transform matrices are provided, which may be different from Embodiment 1, which provides a single feature transform matrix. Accordingly, since any one of a plurality of feature transform matrices may be selectively used depending on the purpose/type of the task, multi-task support may be possible.

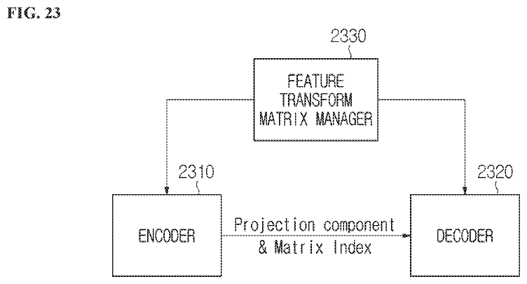

FIG. 23 is a diagram schematically illustrating an encoder/decoder structure according to an embodiment of the present disclosure.

Referring to FIG. 23, an encoder 2310 may encode a feature (or feature map) by performing feature transform based on a feature transform matrix. The feature transform matrix performs a function of reducing the dimension of the feature map, and as described above, may be a global transform matrix that is independent of input data.

The encoder 2310 may perform feature transform by selecting one of a plurality of feature transform matrices maintained/managed by a feature transform matrix manager 2330. In one embodiment, the encoder 2310 may select a feature transform matrix based on a result of comparing the error between a feature reconstructed by each feature transform matrix and an original feature. A specific example is shown in Table 2.

TABLE 2

| | |
|---|---|
| Pᵣₒᵢ = Pᵣₒᵢ(u − μ) | Pₙₒₙ_rot = Pₙₒₙ_roi(u − μ) |
| uᵣₒᵢ' = Pᵣₒᵢ^{T}pᵣₒᵢ + μ | uₙₒₙ_roi' = Pₙₒₙ_roi^{T}pₙₒₙ_roi + μ |
| ${error}_{roi} = \sqrt{\sum {( {u}_{i} - {u}_{i\_roi}^{′} )}^{2}}$ | ${error}_{non\_roi} = \sqrt{\sum {( {u}_{i} - {u}_{i\_non \_roi}^{′} )}^{2}}$ |

```
if (errorᵣₒᵢ > errorₙₒₙ_roi)
  Matrix_index = A
Else
  Matrix_index = B
```

In Table 2, Pᵣₒᵢ may mean a feature transform matrix for a ROI feature, that is, a ROI feature transform matrix, and P_{non_roi} may mean a feature transform matrix for a non-ROI feature, that is, a non-ROI feature transform matrix. In addition, pᵣₒᵢ and p_{non_roi} may mean coefficients obtained by respective feature transform matrices. When feature transform is performed based on PCA, Pᵣₒᵢ and P_{non_roi} may be eigenvectors for features (in this case, it may be some of the eigenvectors rather than all eigenvectors), and pᵣₒᵢ and p_{non_roi} may be principal components extracted through the eigenvectors. In addition, u′ᵣₒᵢ and u′_{non_roi} may mean input features reconstructed through the inverse transform of pᵣₒᵢ and p_{non_roi}.

Referring to Table 2, for the same feature input, by comparing an error errorᵣₒᵢ when transformed and reconstructed based on a non-ROI feature transform matrix and an error error_{non_roi} when transformed and reconstructed based on a ROI feature transform matrix, a feature transform matrix with a smaller error may be selected for feature transform. For example, if the error errorᵣₒᵢ of the ROI feature transform matrix is greater than the error error_{nom_roi} of the non-ROI feature transform matrix, the non-ROI feature transform matrix may be selected for feature transform (i.e., Matrix_index=A). In contrast, if the error errorᵣₒᵢ of the ROI feature transform matrix is less than or equal to the error error_{non_roi} of the non-ROI feature transform matrix, the ROI feature transform matrix may be selected for feature transform (i.e., Matrix_index=B).

The encoder 2310 may encode a matrix index representing the selected feature transform matrix in a bitstream. An example of matrix index settings is shown in Table 3.

TABLE 3

| Feature | Transform Index |
|---|---|
| ROI for object detection | 0 |
| ROI for face recognition | 1 |
| non-ROI | 2 |

Referring to Table 3, the matrix index of the ROI feature for an object detection task may be set to 0, the matrix index of the ROI feature for a face recognition task may be set to 1, and the matrix index of the non-ROI feature may be set to 2. However, since this is only one example, the embodiments of the present disclosure are not limited thereto. For example, unlike the example of Table 3, the matrix index of the non-ROI feature may be set to 0, the matrix index of the ROI feature for the object detection task may be set to 1, and the matrix index of the ROI feature for the face recognition task may be set to 2. In addition, a larger number (e.g., 4) of matrix indexes may be set by subdividing the object detection task by object type.

In this way, the matrix index may be set/derived in various ways.

In some embodiments, the matrix index may be set to be divided into ROI and non-ROI. In addition, the matrix index may be set to be divided by task type. In addition, the matrix index may be set to be divided by predetermined task group.

In some embodiments, the matrix index may be derived according to a predetermined method without being separately encoded/decoded. For example, the matrix index may be derived based on additional information such as an mean value of a feature. In addition, the matrix index may be derived based on the matrix index of a neighboring feature.

In some embodiments, the matrix index of the neighboring feature may be used to encode/decode the matrix index of a current feature. For example, the matrix index of the current feature may be encoded/decoded by a difference with the matrix index of the neighboring feature.

The above-described embodiments may be used individually or in combination of two or more.

The matrix index may be set to represent the selected feature transform matrix step by step.

In some embodiments. ROI and non-ROI may be classified based on a first flag/index, and then ROI may be further classified according to task type based on a second flag/index. Alternatively, after a plurality of tasks is classified based on a third flag/index, tasks may be further classified according to task type based on a fourth flag/index. In this way, the matrix index may be set in 2 steps according to a predetermined classification standard. However, in some embodiments, the matrix index may be classified/set in more steps (e.g., 3-step, 4-step).

In order to efficiently encode a matrix index, various binarization techniques and entropy coding techniques may be used. For example, the matrix index may be encoded using various binarization techniques such as FLC, unary, truncated unary, exponential golomb, golomb rice, etc. In addition, the matrix index may be encoded using various entropy coding techniques such as variable length coding, Huffman coding, and arithmetic coding. In one embodiment, to increase entropy coding efficiency, neighboring information (e.g., matrix index information of neighboring coding units) may be used as context.

Meanwhile, in order to increase encoding/decoding efficiency, information about the feature transform matrix shall be efficiently expressed without duplication within the bitstream. Accordingly, according to Embodiment 2 of the present disclosure, the matrix index may be defined differently for each feature coding unit. An example of a feature coding unit is shown in Table 4.

TABLE 4

| Feature coding unit | Description |
|---|---|
| Sequence level | Entire sequence unit |
| Group of feature set | Set of features extracted from several |
| | continuous inputs (e.g., 30 frames) |
| Feature set | Set of features extracted from one input |
| Feature coding unit | It may be a feature coding unit, a block |
| | having a specific size or a set of blocks |
| | (e.g., size unit of matrix, 8 × 8 unit, etc.) |

Referring to Table 4, the feature coding unit may include a sequence level, a feature set (or feature map) group, a feature set, and a feature coding unit. The sequence level may be subdivided into entire sequence units and partial sequence units.

Tables 5 to 9 exemplarily show syntaxes for encoding information about a feature transform matrix.

TABLE 5

| Sequence_header( ) { | Description |
|---|---|
| AdaptiveFeatureTransform_flag | Information indicating whether |
| | to use a plurality of feature |
| | matrices |
| if (AdaptiveFeatureTransform_flag) | |
| AdaptiveFeatureTransform_Unit | Definition of unit to which feature |
| | matrix is applied (e.g., 0: |
| | sequence, 1: GOF, 2: Featureset, |
| } | 3: Feature coding unit) |

First, referring to Table 5, sequence header may include syntax elements AdaptiveFeatureTransform_flag and AdaptiveFeatureTransform_Unit.

The syntax element AdaptiveFeatureTransform_flag may indicate whether a plurality of feature transform matrices are used.

The syntax element AdaptiveFeatureTransform_Unit may represent a feature coding unit to which a feature transform matrix is applied. For example, AdaptiveFeatureTransform_Unit equal to a first value (e.g., 0) may indicate that the feature transform matrix is applied at a sequence level. In addition, AdaptiveFeatureTransform_Unit equal to a second value (e.g., 1) may indicate that the feature transform matrix is applied in GOF units. In addition, AdaptiveFeatureTransform_Unit equal to a third value (e.g., 2) may indicate that the feature transform matrix is applied in feature set units. In addition, AdaptiveFeatureTransform_Unit equal to a fourth value (e.g., 3) may indicate that the feature transform matrix is applied in feature coding units. Meanwhile, AdaptiveFeatureTransform_Unit may be encoded/signaled only when AdaptiveFeatureTransform_flag has a second value (e.g., 1).

TABLE 6

| Sequence_header( ) { | Description |
|---|---|
| AdaptiveFeatureTransform_flag | Information indicating whether a |
| | plurality of feature matrices is used |
| if (AdaptiveFeatureTransform) | It defines that the feature matrix |
| Sequence_level | is determined to be a sequence level. |
| } | |

Next, referring to Table 6, sequence_header may include syntax elements AdaptiveFeatureTransform_flag and Sequnce_level.

The semantics of the syntax element AdaptiveFeatureTransform_flag are as described above with reference to Table 4.

The syntax element Sequence_level may define that the feature transform matrix is determined to be the sequence level. Sequence_level may be encoded/signaled only when AdaptiveFeatureTransform_flag has a second value (e.g., 1).

TABLE 7

| GOF_header( ) { | Description |
|---|---|
| if (AdaptiveFeatureTransform) | It defines that the feature matrix is |
| GOF_level | determined to be a GOF level. |
| } | |

Next, referring to Table 7, GOF_header may include a syntax element GOF_level.

The syntax element GOF_level may define that the feature transform matrix is determined to be a GOF level. GOF_level may be encoded/signaled only when AdaptiveFeatureTransform flag in Table 4 or Table 5 has a second value (e.g., 1).

TABLE 8

| Featureset_header( ) { | Description |
|---|---|
| if (AdaptiveFeatureTransform) | It defines that the feature matrix is |
| Featureset_level | determined to be a Featureset level. |
| } | |

Next, referring to Table 8, featureset_header may include a syntax element Featureset_level.

The syntax element Featureset_level may define that the feature transform matrix is determined to be a feature set level. Featureset_level may be encoded/signaled only when AdaptiveFeatureTransform_flag in Table 4 or Table 5 has a second value (e.g., 1).

TABLE 9

```
feature_coding( ) {
  ...
  if (AdaptiveFeatureTransform){
    PCA_Data_coding (principal_components,
    information_of_component, Matrix_index )
  }
  Else
    PCA_Data_coding (principal_components,
    information_of_component)
}
```

Next, referring to Table 9, within the feature coding syntax (feature_coding), the PCA_Data_coding function may be called based on the value of the aforementioned syntax element AdaptiveFeatureTransform. Specifically, when AdaptiveFeatureTransform has a second value (e.g., 1) (i.e., when a plurality of feature transform matrices is used), the PCA_Data coding function may be called using the principal component (principal_components), principal component-related information (information_of_component), and matrix index (Matrix_index) as call input values. In contrast, when AdaptiveFeatureTransform has a first value (e.g., 0) (i.e., when one feature transform matrix is used), the PCA_Data_coding function may be called using the principal component (principal_components) and principal component-related information (information_of_component) as call input values.

According to Embodiment 2 of the present disclosure, feature transform may be performed based on a plurality of global feature transform matrices. A plurality of global feature transform matrices may be generated in advance based on a plurality of feature data sets, and may be maintained/managed by a feature transform matrix manager. By using a global feature transform matrix, the encoder and decoder do not need to separately generate/manage the feature transform matrix, so complexity can be reduced and encoding/decoding efficiency can be improved. In addition, since any one of a plurality of feature transform matrices may be selectively used depending on the purpose/type of the task, multi-task support may be possible.

### Embodiment 3

When a feature data set is constructed using only ROI features for a specific machine task, multi-task support is not possible, and the problem arises in which necessary information cannot be efficiently encoded when a task is changed.

To solve this problem, according to Embodiment 3 of the present disclosure, a global feature classification method and a feature transform matrix generation method that are not limited to specific tasks are provided. Hereinafter, Embodiment 3 of the present disclosure will be described in detail with reference to the attached drawings.

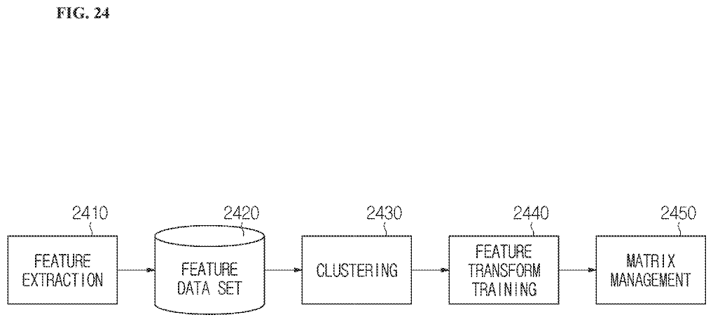

FIG. 24 is a diagram illustrating a feature transform matrix generation method according to an embodiment of the present disclosure.

FIG. 24 schematically illustrates a method of generating a feature transform matrix by clustering feature data sets.

Referring to FIG. 24, in a first stage 2410, features may be extracted from input data, for example, a source image, by a feature extraction network.

In a second stage 2420, feature data sets may be generated from the extracted features by a feature data set generator. In one embodiment, the extracted features may be clustered and then divided into predetermined units for feature transform training. In addition, the divided features may be clustered and then processed into a form that is easy to learn.

In a third stage 2430, the number of groups (or clusters) into which the feature data sets are clustered may be determined by the feature data set generator or the feature transform matrix generator. In general, the number of feature transform matrices may increase in proportion to the number of groups (or clusters). As the number of feature transform matrices increases, feature transform performance can be improved, but since more feature transform matrices shall be stored, an increase in storage cost is inevitable. In addition, the amount of information about the feature transform matrix increases, which may deteriorate overall coding performance. Meanwhile, feature data sets may be classified and clustered based on the determined number of groups.

In a fourth stage 2440, a feature transform matrix may be generated for each generated group by the feature transform matrix generator.

In a fifth stage 2450, the generated feature transform matrix may be maintained/managed by the feature transform matrix manager.

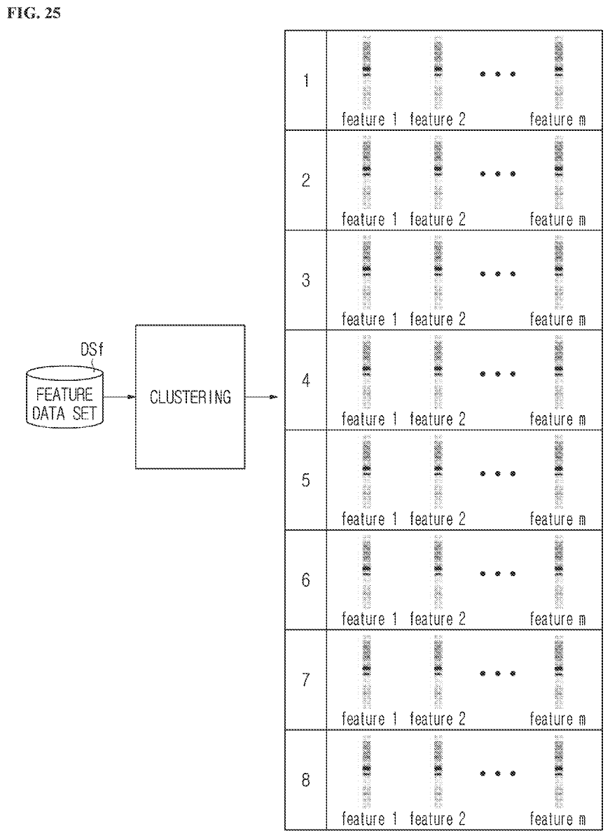

FIG. 25 is a diagram illustrating an example of clustering feature data sets according to an embodiment of the present disclosure.

Referring to FIG. 25, feature data sets DSf may be classified into eight groups (or clusters) based on a predetermined clustering technique, such as a K-mean clustering technique. At this time, each group may be distinguished based on predetermined group information, such as mean and variance. An encoding apparatus may determine which group a current feature belongs to based on the group information, and determine a feature transform matrix to be used for the current feature based on the determination result. Meanwhile, since a decoding apparatus may include information for dimensional reconstruction (e.g., mean value, etc.) in information related to the principal component (Information_of_principal component), a feature transform matrix used during encoding may be inferred and used based on the information.

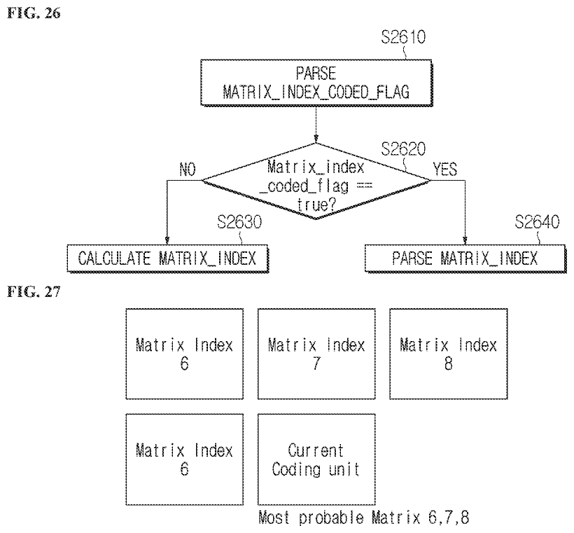

FIG. 26 is a flowchart illustrating a method of determining a feature transform matrix at a decoding apparatus according to an embodiment of the present disclosure.

Referring to FIG. 26, the decoding apparatus may parse Matrix_index_coded_flag obtained from a bitstream (S2610). Matrix_index_coded_flag may indicate whether the feature transform matrix index (e.g., Matrix_index) is encoded. For example, Matrix_index_coded_flag equal to a first value (e.g., 0 or False) may indicate that the feature transform matrix index is not encoded. In contrast, Matrix_index_coded_flag equal to a second value (e.g., 1 or True) may indicate that the feature transform matrix index is encoded.

The decoding apparatus may determine whether Matrix_index_coded_flag is a second value (e.g., 1 or True) (S2620).

If matrix_index_coded_flag is equal to a first value (e.g., 0 or False) (‘NO’ in S2820), the decoding apparatus may calculate (or derive) a feature transform matrix index according to a predetermined rule (S2630). In addition, the decoding apparatus may determine a feature transform matrix for a current feature based on the calculated feature transform matrix index. For example, the decoding apparatus may derive a feature transform matrix based on information for dimensional reconstruction (e.g., mean value, etc.) included in the principal component-related information (information_of_principal component).

In contrast, when Matrix_index_coded_flag is equal to a second value (e.g., 1 or True) (‘YES’ in S2820), the decoding apparatus may parse the feature transform matrix index (e.g., Matrix_index) obtained from the bitstream (S2640). In addition, the decoding apparatus may determine the feature transform matrix for the current feature based on the parsed feature transform matrix index.

Meanwhile, since adjacent feature coding units have similar properties, various contexts in the feature coding process may also be similar, and in particular, may have identical/similar feature transform matrix index values. Accordingly, in one embodiment, the feature transform matrix index may be encoded based on the feature transform matrix index information of the neighboring feature.

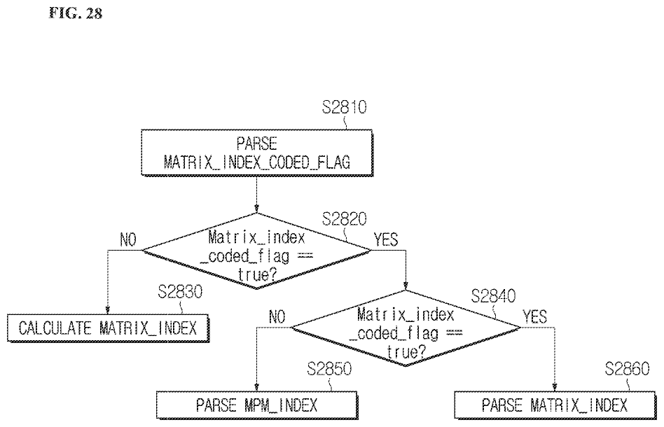

FIGS. 27 and 28 are diagrams illustrating a MPM encoding method of a feature transform matrix index according to an embodiment of the present disclosure.

First, referring to FIG. 27, if feature transform matrices with indices 6 to 8 were used in the previous encoding process, there is a high possibility that a feature transform matrix for a current feature is also one of the feature transform matrices with indices 6 to 8. Accordingly, by constructing a Most Probable Matrix (MPM) list using the feature transform matrices with indices 6 to 8 and encoding only information related to the MPM list, the amount of information required for encoding the feature transform matrix index can be reduced. At this time, the MPM encoding method of the feature transform matrix index may be the same/similar to the MPM encoding method of the existing video codec, for example, the VVC (Versatile Video Codec) standard.

FIG. 28 is a flowchart illustrating a method of determining a feature transform matrix at a decoding apparatus according to an embodiment of the present disclosure. Hereinafter, a repeated description of the method of FIG. 26 will be described.

Referring to FIG. 28, the decoding apparatus may parse Matrix_index_coded_flag obtained from a bitstream (52810).

The decoding apparatus may determine whether Matrix_index_coded_flag is equal to a second value (e.g., 1 or True) (S2820).

If matrix_index_coded_flag is equal to a first value (e.g., 0 or False) (‘NO’ in S3020), the decoding apparatus may calculate (or derive) a feature transform matrix index according to a predetermined rule (S2830). Then, the decoding apparatus may determine a feature transform matrix for a current feature based on the calculated feature transform matrix index (S2830). For example, the decoding apparatus may derive a feature transform matrix based on information for dimensional reconstruction (e.g., Mean value, etc.) included in the principal component-related information (information_of_principal component).

In contrast, if Matrix_index_coded flag is equal to a second value (e.g., 1 or True) (‘YES’ in S2820), the decoding apparatus may determine whether MPM_flag obtained from the bitstream is equal to a second value (e.g., 1 or True). (S2840). MPM_flag may indicate whether the feature transform matrix for the current feature exists in the MPM (Most Probable Matrix) list. For example, MPM_flag equal to a first value (e.g., 0 or False) may indicate that the feature transform matrix for the current feature does not exist in the MPM list. In contrast, MPM_flag equal to a second value (e.g., 1 or True) may indicate that the feature transform matrix for the current feature exists in the MPM list.

If MPM_flag is equal to a second value (e.g., 1 or True) (‘YES’ in S3040), the decoding apparatus may parse the MPM index (e.g., MPM_index) (S2850). In addition, the decoding apparatus may determine the feature transform matrix for the current feature based on the parsed MPM index.

In contrast, when MPM_flag is equal to a first value (e.g., 0 or False) (‘NO’ in S3040), the decoding apparatus may parse the feature transform matrix index (e.g., Matrix index) (S2860). In addition, the decoding apparatus may determine the feature transform matrix for the current feature based on the parsed feature transform matrix index.

According to Embodiment 3 of the present disclosure, by generating a feature transform matrix based on a clustered feature data set, it is possible to use a global feature transform matrix that is not limited to a specific task. Accordingly, multi-task support becomes possible, and necessary information may be efficiently encoded even if the task changes. In addition, according to Embodiment 3 of the present disclosure, the feature transform matrix may be determined using predetermined flag information (e.g., Matrix_index_coded_flag, MPM_flag, etc.). Accordingly, signaling overhead can be reduced and encoding/decoding efficiency can be further improved.

### Embodiment 4

Embodiment 4 of the present disclosure provides a method of utilizing a PCA technique in feature data compression.

After performing principal component analysis on feature data, an encoding apparatus may determine the number of principal components that may optimally express the feature data to be encoded. At this time, matters to be considered in determining the number of optimal principal components include the size of information related to principal component analysis to be transmitted to the decoding apparatus (e.g., mean and principal component feature data, principal component coefficients for each feature) and prediction accuracy of the original feature data according to the number of principal components, etc.

An example of a method of reconstructing feature map data is shown in Table 10.

TABLE 10

| ${Pred}_{x} = μ + {\sum }_{i = 0}^{n - 1} {p}_{x ( i )} \cdot {c}_{i} \qquad ( Equation 1 )$ | |
|---|---|
| Resid = f − Pred | (Equation 2) |

Referring to Table 10, the prediction value Predₓ of the feature map data fx may be obtained according to Equation 1. In Equation 1, μ refers to the mean of all feature map data, Pₓ₍ᵢ₎ refers to a coefficient projected into each principal component, and Ci may refer to each principal component.

In addition, according to Equation 2, the residual value Resid of the feature map data fx may be obtained by subtracting the prediction value Predₓ, which is the reconstructed feature map data, from the original feature map data. The encoding apparatus may generate a bitstream by encoding the residual value Resid (i.e., residual encoding).

Likewise, the decoding apparatus may decode the feature map data fx based on the reconstructed residual value Resid. For example, the decoding apparatus may reconstruct the residual value Resid of the feature map data fx based on the residual signal obtained from the bitstream. In addition, the decoding apparatus may reconstruct the prediction value Predₓ of the feature map data fx according to Equation 1. In addition, the decoding apparatus may decode the feature map data fx by adding the reconstructed residual value Resid and the prediction value Predₓ.

An example of feature coding syntax feature_coding according to Embodiment 4 is shown in Table 11.

TABLE 11

```
feature_coding( ) {
  ...
  if ( FeaturePredMode === PCA) {
    PCA_Data_coding (principal_components,
    information_of_component)
    for ( i=0; i<num_feature_channel; i++ ) {
      skip_channel[i]
      if (!skip_channel[i])
        resid_data_coding(resid[i])
    }
  }
  ...
}
```

Referring to Table 11, within feature coding syntax feature_coding, it may be determined whether a feature prediction mode is a PCA mode (FeaturePredMode=PCA). Here, the PCA mode may refer to a mode for predicting feature map data using the above-described PCA technique.

As a result of the determination, if the feature prediction mode is a PCA mode, a PCA_Data coding function may be called using principal components (principal_components) and principal component related information (information_of_component) as call input values. When the PCA_Data coding function is called, principal component data may be transmitted. In addition, a syntax element skip_channel[i] may be encoded within the feature coding syntax feature_coding, skip_channel[i] may be flag information indicating whether skip mode is applied to each channel of feature map data. For example, skip_channel[i] equal to a first value (e.g., 0 or False) may indicate that residual data of feature map data is encoded for the i-th channel (i.e., skip mode is not applied). In contrast, skip_channel[i] equal to a second value (e.g., 1 or True) may indicate that the residual data of feature map data is not encoded for the i-th channel (i.e., skip mode is applied).

Only when skip_channel[i] is equal to a first value (e.g., 0 or False), a resid_data_coding function for residual data transmission may be called within the feature coding syntax feature coding. If skip_channel[i] is equal to a second value (e.g., 1 or True), the residual data is not transmitted separately, and the decoding apparatus use a prediction value reconstructed based on the PCA prediction data as reconstructed feature map data.

According to Embodiment 4 of the present disclosure, various coding techniques and syntax structures for compression/reconstruction of feature map data can be provided. To the extent that the purpose and characteristics of VCM are not impaired, compression/decompression technology of existing video codecs, such as the Versatile Video Codec (VVC) standard, may be applied to the present disclosure. Accordingly, encoding/decoding efficiency can be further improved.

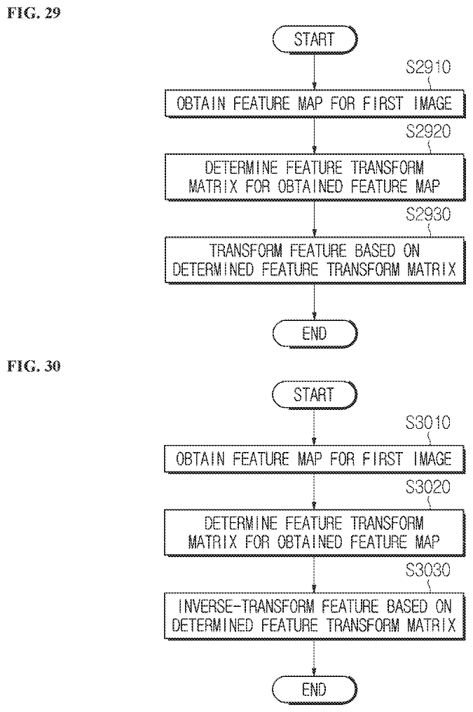

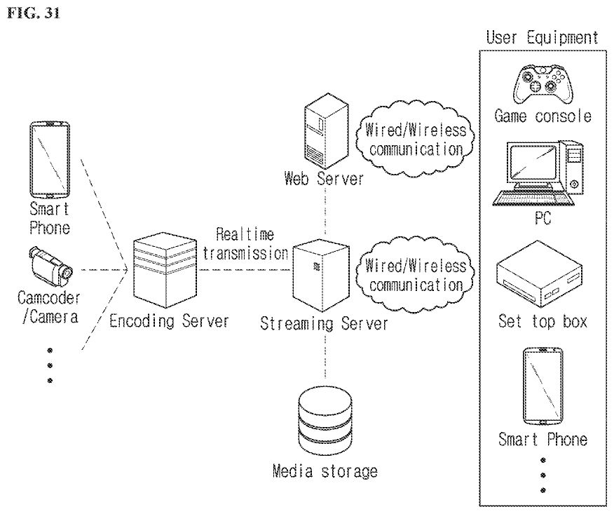

Hereinafter, a method of encoding/decoding feature information of an image according to an embodiment of the present disclosure will be described in detail with reference to FIGS. 29 and 30.

FIG. 29 is a flowchart illustrating a feature information encoding method according to an embodiment of the present disclosure. The feature information encoding method of FIG. 29 may be performed by the encoding apparatus of FIG. 7.

Referring to FIG. 29, the encoding apparatus may obtain at least one feature map for a first image (52910).

Here, the first image may refer to a video/image source generated by a source image generator. In some embodiments, the source image generator may be an independent external device (e.g., camera, camcorder, etc.) implemented to enable communication with the encoding apparatus. Alternatively, the source image generator may be an internal device (e.g., image sensor module, etc.) implemented to perform limited functions such as video/image capture.

A feature map may refer to a set of features (i.e., feature set) extracted from an input image using a feature extraction method based on an artificial neural network (e.g., CNN, DNN, etc.). In some embodiments, feature map extraction may be performed by a feature extraction network outside the encoding apparatus. In this case, “obtaining a feature map” may mean receiving a feature map from a feature extraction network. Alternatively, feature map extraction may be performed by an encoding apparatus. In this case, “obtaining a feature map” may mean extracting a feature map from the first image.

The encoding apparatus may determine at least one feature transform matrix for the obtained feature map (S2920). Here, at least one feature transform matrix may include a global feature transform matrix commonly applied to two or more features.

The global feature transform matrix may be generated based on a predetermined feature data set obtained from a second image. Here, the second image may mean a predetermined input data set that has a task performance result (e.g., object detection result in an object detection task) as label information.

The global feature transform matrix may be generated by an external device, for example, the feature transform matrix generator described above with reference to FIG. 16. In this case, the feature transform matrix generator may generate a feature transform matrix (e.g., eigenvector) and matrix information (e.g., eigenvalues, applicable task type, etc.) by performing feature transform training using the feature data set. In addition, the generated global feature transform matrix may be maintained/managed by an external device, for example, the feature transform matrix manager described above with reference to FIG. 16. In this case, the feature transform matrix manager may store the feature transform matrix and matrix information in a predetermined storage space, and provide related information to the encoder and/or decoder upon request. In some embodiments, the feature transform matrix manager and the feature transform matrix generator may construct one physical or logical entity.

In one embodiment, the number of global feature transform matrices used for feature transform may be determined differently depending on the type of target task. For example, if the target task is a machine task such as object detection, the number of global feature transform matrices used for feature transform may be only one. On the other hand, when the target task is a hybrid task that is a combination of machine tasks and human vision, the number of global feature transform matrices used for feature transform may be plural.

In one embodiment, the global feature transform matrix may be generated by applying a predetermined dimensionality reduction algorithm, such as principal component analysis (PCA) or sparse coding algorithm, to the feature data set.

In one embodiment, the feature data set may include a plurality of features selected (or chosen) from at least one feature map for the second image. That is, the feature data set may be constructed using some features selected from among the features extracted from the second image. At this time, the plurality of selected features may have a modified data structure within the feature data set. That is, the data structure of the plurality of selected features may be transformed into a form that is easy to learn and then input as a feature data set.

In one embodiment, the feature data set may include only a plurality of region of interest (ROI) features obtained from the second image. Alternatively, the feature data set may be generated individually for each of the ROI features and non-ROI features obtained from the second image.

In one embodiment, features obtained from the second image may be clustered and included in the feature data set.

In one embodiment, the encoding apparatus may encode matrix index information representing the determined feature transform matrix. An example of matrix index information is as described above with reference to Table 3. The feature transform matrix may be determined based on a most probable matrix (MPM) list for the current feature. The MPM list may include a feature transform matrix for a feature encoded before the current feature as an MPM candidate. If an MPM candidate identical to the feature transform matrix for the current feature exists in the MPM list, the encoding apparatus may encode an MPM index indicating the corresponding MPM candidate. In this case, the decoding apparatus may determine the feature transform matrix for the current feature based on the MPM index obtained from the encoding apparatus.

The encoding apparatus may transform a plurality of features included in the feature map based on the feature transform matrix determined in step S2920 (S2930).

Meanwhile, in encoding feature information, video codec techniques such as prediction, residualization, skip mode, etc. may be used, the specific details of which are as described above with reference to Tables 10 and 11 and thus separate descriptions will be omitted.

FIG. 30 is a flowchart illustrating a feature information decoding method according to an embodiment of the present disclosure. The feature information decoding method of FIG. 30 may be performed by the decoding apparatus of FIG. 7.

Referring to FIG. 30, the decoding apparatus may obtain at least one feature map for a first image (S3010). Here, the feature map may mean feature map data compressed/encoded by an encoding apparatus. The feature map data may be obtained through a bitstream. In this case, feature map data and additional information required for feature map reconstruction may be transmitted through different bitstreams.

The decoding apparatus may determine at least one feature transform matrix for the obtained feature map (S3020). Here, at least one feature transform matrix may include a global feature transform matrix commonly applied to two or more features.

The global feature transform matrix may be generated based on a predetermined feature data set obtained from a second image. Here, the second image may mean a predetermined input data set that has the task performance result (e.g., object detection result in an object detection task) as label information.

The global feature transform matrix may be generated by an external device, for example, the feature transform matrix generator described above with reference to FIG. 16. In addition, the generated global feature transform matrix may be maintained/managed by an external device, for example, the feature transform matrix manager described above with reference to FIG. 16.

In one embodiment, the number of global feature transform matrices used for feature transform may be determined differently depending on the type of target task. For example, if the target task is a machine task such as object detection, the number of global feature transform matrices used for feature transform may be only one. On the other hand, when the target task is a hybrid task that is a combination of machine tasks and human vision, the number of global feature transform matrices used for feature transform may be plural.

In one embodiment, the global feature transform matrix may be generated by applying a predetermined dimensionality reduction algorithm, such as principal component analysis (PCA) or sparse coding algorithm, to the feature data set.

In one embodiment, the feature data set may include a plurality of features selected (or chosen) from at least one feature map for a second image. That is, the feature data set may be constructed using some features selected from among the features extracted from the second image. At this time, the plurality of selected features may have a modified data structure within the feature data set. That is, the data structure of the plurality of selected features may be transformed into a form that is easy to learn and then input as a feature data set.

In one embodiment, the feature data set may include only a plurality of region of interest (ROI) features obtained from the second image. Alternatively, the feature data set may be generated individually for each of the ROI features and non-ROI features obtained from the second image.

In one embodiment, features obtained from the second image may be clustered and included in the feature data set.

In one embodiment, the decoding apparatus may decode matrix index information representing the determined feature transform matrix. An example of matrix index information is as described above with reference to Table 3. The feature transform matrix may be determined based on a most probable matrix (MPM) list for the current feature. The MPM list may include a feature transform matrix for a feature encoded before the current feature as an MPM candidate. If an MPM candidate identical to the feature transform matrix for the current feature exists in the MPM list, the decoding apparatus may determine the feature transform matrix for the current feature based on the MPM index obtained from the encoding apparatus.

The decoding apparatus may inversely transform a plurality of features included in the feature map based on the feature transform matrix determined in step S3020 (S3030).

Meanwhile, in decoding feature information, video codec techniques such as prediction, residualization, skip mode, etc. may be used, the specific details of which are as described above with reference to Tables 10 and 11.

According to the feature information encoding/decoding method described above with reference to FIGS. 29 and 30, feature transform/inverse transform may be performed based on the global feature transform matrix. The global feature transform matrix may be generated in advance based on a predetermined feature data set and maintained/managed by a feature transform matrix manager. Accordingly, since the encoding/decoding apparatus does not need to separately generate/manage the feature transform matrix, complexity can be reduced and encoding/decoding efficiency can be further improved.

In addition, feature transform may be performed based on a plurality of global feature transform matrices. Accordingly, since any one of a plurality of feature transform matrices may be selectively used depending on the purpose/type of the task, multi-task support may be possible.

In addition, by generating a feature transform matrix based on a clustered feature data set, it is possible to use a global feature transform matrix that is not limited to a specific task. Accordingly, multi-task support becomes possible, and necessary information can be efficiently encoded even if the task changes.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some steps.

In the present disclosure, the image encoding apparatus or the image decoding apparatus that performs a predetermined operation (step) may perform an operation (step) of confirming an execution condition or situation of the corresponding operation (step). For example, if it is described that predetermined operation is performed when a predetermined condition is satisfied, the image encoding apparatus or the image decoding apparatus may perform the predetermined operation after determining whether the predetermined condition is satisfied.

The various embodiments of the present disclosure are not a list of all possible combinations and are intended to describe representative aspects of the present disclosure, and the matters described in the various embodiments may be applied independently or in combination of two or more.

Various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

In addition, the image decoding apparatus and the image encoding apparatus, to which the embodiments of the present disclosure are applied, may be included in a multimedia broadcasting transmission and reception device, a mobile communication terminal, a home cinema video device, a digital cinema video device, a surveillance camera, a video chat device, a real time communication device such as video communication, a mobile streaming device, a storage medium, a camcorder, a video on demand (VoD) service providing device, an OTT video (over the top video) device, an Internet streaming service providing device, a three-dimensional (3D) video device, a video telephony video device, a medical video device, and the like, and may be used to process video signals or data signals. For example, the OTT video devices may include a game console, a blu-ray player, an Internet access TV, a home theater system, a smartphone, a tablet PC, a digital video recorder (DVR), or the like.

FIG. 31 is a view illustrating an example of a content streaming system, to which embodiments of the present disclosure are applicable.

Referring to FIG. 31, the content streaming system, to which the embodiment of the present disclosure is applied, may largely include an encoding server, a streaming server, a web server, a media storage, a user device, and a multimedia input device.

The encoding server compresses contents input from multimedia input devices such as a smartphone, a camera, a camcorder, etc. into digital data to generate a bitstream and transmits the bitstream to the streaming server. As another example, when the multimedia input devices such as smartphones, cameras, camcorders, etc. directly generate a bitstream, the encoding server may be omitted.

The bitstream may be generated by an image encoding method or an image encoding apparatus, to which the embodiment of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server may deliver it to a streaming server, and the streaming server may transmit multimedia data to the user. In this case, the contents streaming system may include a separate control server. In this case, the control server serves to control a command/response between devices in the contents streaming system.

The streaming server may receive contents from a media storage and/or an encoding server. For example, when the contents are received from the encoding server, the contents may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (e.g., smartwatches, smart glasses, head mounted displays), digital TVs, desktops computer, digital signage, and the like.

Each server in the contents streaming system may be operated as a distributed server, in which case data received from each server may be distributed.

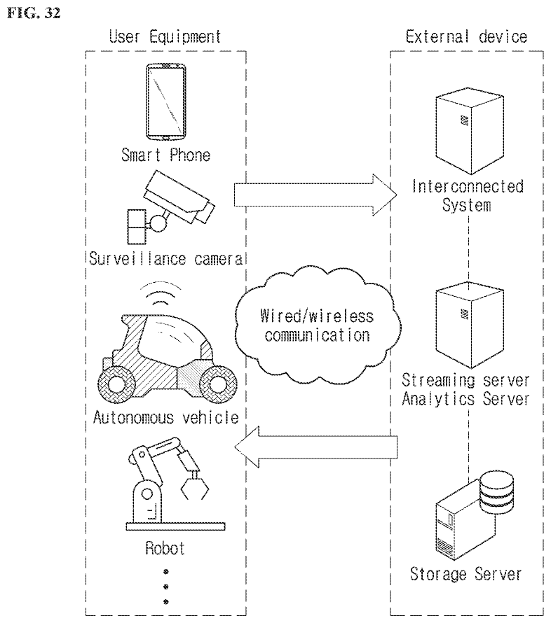

FIG. 32 is a diagram illustrating another example of a content streaming system to which embodiments of the present disclosure are applicable.

Referring to FIG. 32, in an embodiment such as VCM, a task may be performed in a user terminal or a task may be performed in an external device (e.g., streaming server, analysis server, etc.) according to the performance of the device, the users request, the characteristics of the task to be performed, etc. In this way, in order to transmit information necessary to perform a task to an external device, the user terminal may generate a bitstream including information necessary to perform the task (e.g., information such as task, neural network and/or usage) directly or through an encoding server.

In an embodiment, the analysis server may perform a task requested by the user terminal after decoding the encoded information received from the user terminal (or from the encoding server). At this time, the analysis server may transmit the result obtained through the task performance back to the user terminal or may transmit it to another linked service server (e.g., web server). For example, the analysis server may transmit a result obtained by performing a task of determining a fire to a fire-related server. In this case, the analysis server may include a separate control server. In this case, the control server may serve to control a command/response between each device associated with the analysis server and the server. In addition, the analysis server may request desired information from a web server based on a task to be performed by the user device and the task information that may be performed. When the analysis server requests a desired service from the web server, the web server transmits it to the analysis server, and the analysis server may transmit data to the user terminal. In this case, the control server of the content streaming system may serve to control a command/response between devices in the streaming system. The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

The embodiments of the present disclosure may be used to encode/decode feature information.

What is claimed is:

1. A method of decoding feature information of an image performed by a decoding apparatus, the method comprising:
obtaining at least one feature map for a first image,
determining at least one feature transform matrix for the feature map; and
inversely transforming a plurality of features included in the feature map based on the determined feature transform matrix,
wherein the at least one feature transform matrix comprises a global feature transform matrix commonly applied to two or more features, and
wherein the global feature transform matrix is generated in advance based on a predetermined feature data set obtained from a second image.

2. The method of claim 1, wherein the number of global feature transform matrix is differently determined according to a type of a target task performed based on the feature map.

3. The method of claim 1, wherein the global feature transform matrix is generated by applying a predetermined dimensionality reduction algorithm to the feature data set.

4. The method of claim 1, wherein the feature data set comprises at least one feature selected from among a plurality of features obtained from the second image.

5. The method of claim 4, wherein the selected feature has a modified data structure within the feature data set.

6. The method of claim 1, wherein the feature data set comprises only a plurality of regions of interest (ROIs) obtained from the second image.

7. The method of claim 1, wherein the feature data set is individually generated for ROI features and non-ROI features obtained from the second image.

8. The method of claim 1, wherein the feature transform matrix is determined based on matrix index information obtained from a bitstream.

9. The method of claim 1, wherein features obtained from the second image are clustered and included in the feature data set.

10. The method of claim 1,
wherein the feature transform matrix is determined based on a most probable matrix (MPM) list for a current feature, and
wherein the MPM list comprises a feature transform matrix for a feature reconstructed before the current feature as a MPM candidate.

11. The method of claim 1, wherein the feature map is decoded based on a prediction value obtained from a plurality of inversely transformed features.

12. A method of encoding feature information of an image performed by an encoding apparatus, the method comprising:
obtaining at least one feature map for a first image;
determining at least one feature transform matrix for the feature map; and
transforming a plurality of features included in the feature map based on the determined feature transform matrix,
wherein the at least one feature transform matrix comprises a global feature transform matrix commonly applied to two or more features, and
wherein the global feature transform matrix is generated in advance based on a predetermined feature data set obtained from a second image.

13. The method of claim 12, wherein the number of global feature transform matrix is differently determined according to a type of a target task performed based on the feature map.

14. The method of claim 12, wherein the global feature transform matrix is generated by applying a predetermined dimensionality reduction algorithm to the feature data set.

15. A computer-readable recording medium storing a bitstream generated by a method of encoding feature information of an image, the encoding method comprising:
obtaining at least one feature map for a first image;
determining at least one feature transform matrix for the feature map; and
transforming a plurality of features included in the feature map based on the determined feature transform matrix,
wherein the at least one feature transform matrix comprises a global feature transform matrix commonly applied to two or more features, and
wherein the global feature transform matrix is generated in advance based on a predetermined feature data set obtained from a second image.
